(19) United States
(12) Patent Application Publication
(10) Pub. No.: US 2011/0036228 A1
(43) Pub. Date: Feb. 17, 2011

(54) Stringed Instrument Improvement

(76) Inventor: Brent Douglas Deck, (US)

Correspondence Address: Brent Douglas Deck, P.O.Box 172111, Kansas City, KS, 66117, US

(21) Appl. No.: 12/842,028

(22) Filed: Jul. 22, 2010

Related U.S. Application Data
(60) Provisional application No. 61/271,586, filed on Jul. 22, 2009.

(51) Int. Cl. G10D 3/00

(52) U.S. Cl. 84/313

(57) ABSTRACT

This invention relates to improvements to a stringed musical instrument, and more particularly to guitar design for use with transposing vibrato mechanisms.

Vibrato devices for guitars are known. The present device and method improve the ability to of a player to bend entire chords in a manner that maintains harmonic relationship between the individual strings.

The invention also included improved manual controls and means to extend the transposing range of such a vibrato device.

This application is a continuation-in-part of U.S. Utility application Ser. No. 12/283,668 filed Sep. 15, 2008. This application also claims priority benefit from PCT/US10/27736 filed Mar. 17, 2010, and from U.S. Provisional application 61/271,586 filed Jul. 22, 2009.

### FIELD OF INVENTION

The present invention relates to devices which enhance the expressive qualities of a stringed musical instrument by empowering the artist to “bend” notes and chords in a harmonic manner.

### BACKGROUND

Non-harmonic vibrato devices are known, typified by U.S. Pat. No. 2,741,146, which allows the musician to change the tension on all guitar stings in unison by activating a lever, without correcting for relative pitch between strings.

Subsequent devices, typified by Jones, U.S. Pat. No. 3,411,394, correct pitch by varying the length or angle of a crank arm or the radius of a string bearing cam. These devices suffer from one or more of the shortcomings of imprecise geometry, expressive difficulty, lack of range, tuning difficulty, and tuning instability.

Floating vibrato devices which both increase and decrease the string pitch from a neutral pitch suffer from tuning instability, aggravated by broken strings, temperature, and simple left hand string bends.

Methods previously used to stabilize a vibrato, such as cam locks, or flats on activating cams, interfere with the smooth expressive motion of the vibrato.

### SUMMARY

The present invention improves the state of the art by utilizing tangential motion of string guides in a configuration that is significantly more accurate in pitch correction than the prior art. The guides are fixed relative to a pivoting tailpiece and cause the strings to be stretched or relaxed when the tailpiece is rotated, while maintaining relative pitch between the strings.

The enhanced accuracy allows the device to be made smaller than prior devices without loss of performance. When built at a larger scale, its geometric accuracy reduces required setup accuracy. Accuracy of the device may be further enhanced by proper attention to string clamping and neck rigidity.

Dual axis control allows a musician to sweep easily from “bend” to “dive” (sharp to flat) while using the muscles on only one side of the hand and wrist. Dual axis control allows biasing tailpiece against a separate stop on a separate axis after either a bend or a dive, with enhanced stablity at neutral pitch, and no locking mechanism.

Alternatively, a cam-enabled return spring maintains neutral tuning when the device is released without adversely affecting motion of the device.

The device also includes a beneficial combination of pitch-relative vibrato means with standard vibrato means, where a standard vibrato displacement may be used to compensate for non-linearities in string tension while transposing over large spans.

### OBJECTS OF THE INVENTION

1) It is an object of the invention to provide an expressive vibrato device which bends chords while accurately maintaining relative pitch over a wide range of adjustment.
2) It is an object of the invention to provide a means of operating the device which allows smooth transitions from sharp to flat.
3) It is an object of the invention to provide a means of operating the device which provides tonal stability when the device is inactive.
4) It is an object of the invention to provide a means of operating the device which requires less effort and coordination than the prior art.
5) It is an object of the invention to provide a device which is easier to tune and maintains tune better than the prior art.
6) It is an object of the invention to provide a device which allows mixing of harmonic and non harmonic tonal effects.
7) It is an object of the invention to provide a vibrato mechanism with transposing capability over a broad range with increased accuracy, and without adversely affecting expression.

### DRAWINGS

FIGS. 1A and 1B are schematics showing geometric construction of string guide path.

FIGS. 2A through 2H and 2J are top views of various embodiments of tuning heads using zero fret and guide post improvements.

FIGS. 3A and 3B are side views of a vibrato mechanism with rotational axis substantially parallel to the bridge.

FIG. 3C is a top view of a vibrato housing with rotational axis substantially parallel to the bridge.

FIGS. 4A and 4B are top views of a vibrato mechanism with rotational axis perpendicular to plane of strings.

FIG. 4C is a side view of a flat plate vibrato mechanism with rotational axis perpendicular to plane of strings.

FIG. 5A is a side view of a vibrato mechanism with rotational axis parallel to bridge where combined string guide and anchor are suspended within an arcuate shell.

FIG. 5B is a side view of a vibrato mechanism having a string guides supported on a slotted arcuate main member.

FIG. 5C is a top view the mechanism of FIG. 5B, and further showing schematic transposing means attached to control arm.

FIGS. 5D, 5E, and 5F are side views of vibrato devices having main rotating member displaced from string plane, sans control means illustration.

FIGS. 6A and 6B are side views of a vibrato devices having variable length actuator cranks engaging ball receiver crank arms.

FIG. 6C is a rear view of the device depicted in FIG. 6B, sans control arm, dive transport, and bias spring means.

FIG. 6D is a side view of a vibrato device having a variable length actuator cranks displaced from string plane, sans control means illustration.

FIG. 7 is a perspective view of a composite neck having adjustable zero fret.

FIG. 8A through 8D are side views of a flat plate tailpiece with axis perpendicular to string plane and body.

FIG. 9A through 9C are schematic top views of various control cam and return spring configurations on a flat plate vibrato tailpiece.

FIGS. 10A and 10B are top and side views of a control arm having electronic sensors measuring displacement about two axes.

FIGS. 10C and 10D are top and side views of a control arm having electronic sensors measuring torque about two axes.

FIG. 10E is a flow chart of a digital processing circuit for an electronic vibrato arm.

FIG. 11A is a top view of a standard vibrato device incorporating an electronic harmonic vibrator arm.

FIGS. 11B and 11C are side views of a standard vibrato device incorporating an electronic harmonic vibrator arm.

FIGS. 12A and 12B are top views of a vibrato assembly having integral leaf spring means and novel control arm configurations.

FIG. 13 is a top view of an arcuate guide path slot and guide having gear teeth means for adjustment.

FIGS. 14A, 14B, and 14C are top views of an multi-surface actuator cams or assemblies.

FIG. 15 is a top view of an alternative adjustment means having linear slots on a flat plate approximating the preferred embodiment.

FIG. 16A is a top view of a flat plate vibrato device having single axis harmonic action, simple transposing means, and extreme bend capability.

FIGS. 16B and 16C are top and side views of an eccentric transposing mechanism for a harmonic vibrator device.

FIGS. 16D, 16E, 16F, and 16G are top views of various transposing cam configurations.

FIG. 16H is a top view of a flat plate vibrato device having single axis harmonic action, leaf return spring means, multilobe cam transposer and idler lever, and various string anchor means.

FIGS. 17A, 17B, and 17C are side views of a standard vibrato device incorporating present control improvements.

FIG. 17D illustrates surface relief means in control arm components to enhance non-axial rigidity of pivot means.

FIGS. 17E and 17F illustrate standard vibrato with variable bias tension

FIGS. 18A and 18B are side views of flat plate combined harmonic/standard vibrato devices adapted for use on a guitar body routed for a standard bias spring block.

FIG. 18C is side views of a flat plate combined harmonic/standard vibrato device adapted for bolting on top of a solid guitar body.

FIGS. 19A, 19B, 19C and 19D are top views of a flat plate combined harmonic/standard vibrato device having idler link between transposing hub and control arm hub.

FIGS. 19E, 19F, and 19G are side views of a flat plate combined harmonic/standard vibrato device having idler link between transposing hub and control arm hub.

FIGS. 19G and 19H are side views of a flat plate combined harmonic/standard vibrato device having idler link between transposing hub and control arm hub, and further having secondary base to pivot during standard vibrato actions.

FIGS. 19J, 19K, and 19L are top views of examples of simple flex compensation cams.

FIGS. 20A and 20B are side views of flat plate combined harmonic/standard vibrato devices where the harmonic dive transport mechanism pivots relative to the baseplate.

FIGS. 21A, 21B, 21C and 21D are side views of a combined harmonic/standard vibrato device having main axis parallel to bridge, and control arm pivoting from main rotating member.

FIG. 21E is a side view of a combined harmonic/standard vibrato device having all bend and dive axes parallel to the bridge, and control arm fixed to the main member.

FIGS. 22A and 22B are side views of a combined harmonic/standard vibrato device having main axis parallel to bridge, having single axis harmonic action, and leaf return spring means.

FIGS. 23A, 23B, and 23C are side views of a combined harmonic/standard vibrato device having main axis parallel to bridge, having dual axis harmonic action.

FIG. 23D is a side view of a vibrato as in FIG. 23A, and further including extreme bend means for one or more strings.

FIGS. 24A, 24B, and 24C are side views of harmonic device having bias springs concealed within the instrument body.

FIG. 25A is a side view of a vibrato embodiment having harmonic bend and standard dive, with control arm journal brake when not in use.

FIG. 25B is an embodiment having a control arm journal rotating on a fixed control arm shaft cantilevered from the device base, and further having a transport device pivoting from that journal on an axis substantially parallel to the string plane.

FIGS. 25C and 25D illustrate embodiments where the bend and dive actions are controlled by the interaction between rollers rotating on skewed axes, and where the dive transport pivots from the control arm journal or shaft.

FIGS. 25E and 25F illustrate embodiments where the bend and dive actions are controlled by the interaction between rollers rotating on skewed axes, and where the control arm journal or shaft pivots relative to the dive transport mechanism.

### DESCRIPTION

In this discussion, traditional, non-transposing vibrato action and components thereof shall be referred to as “standard”; e.g. standard dive, bias, bend, bias stop. Pitch-relative vibrato action and components thereof shall be referred to as “harmonic”; e.g. harmonic dive, bias, bend, bias stop.

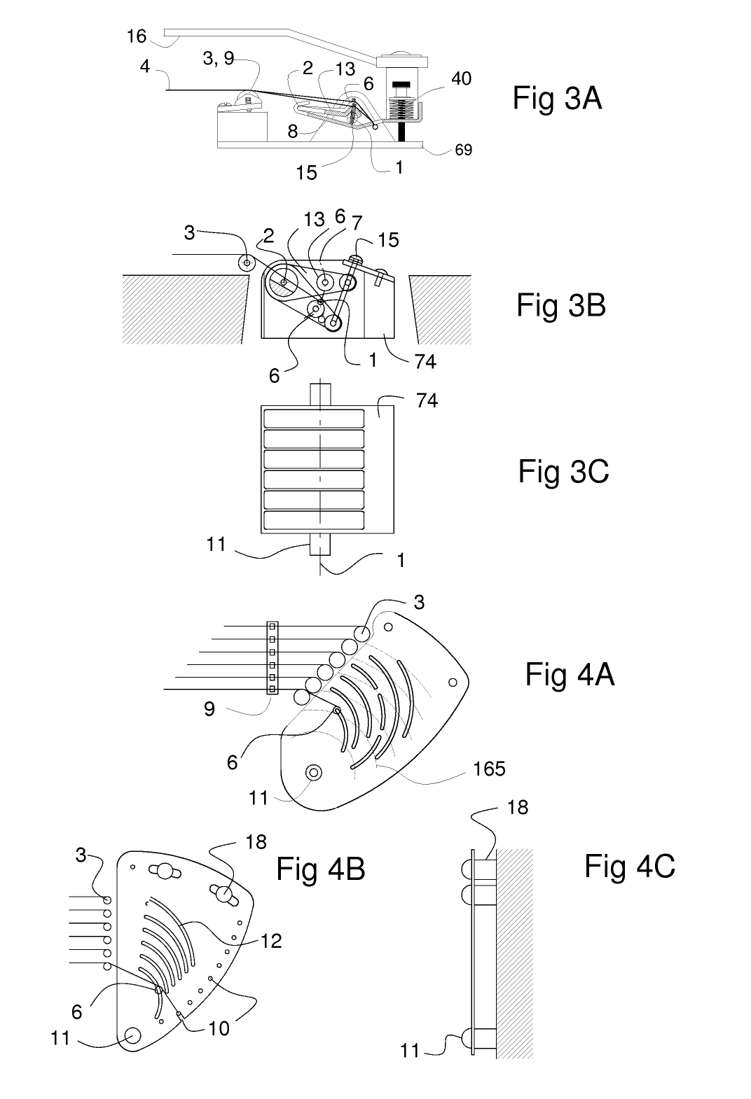

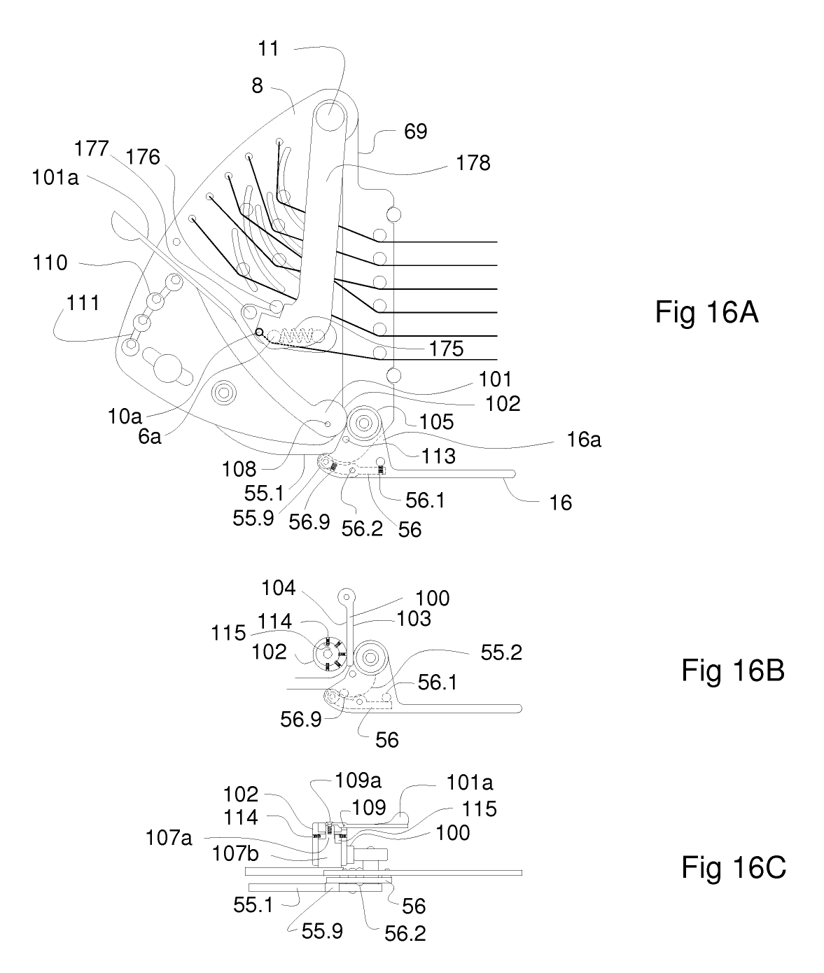

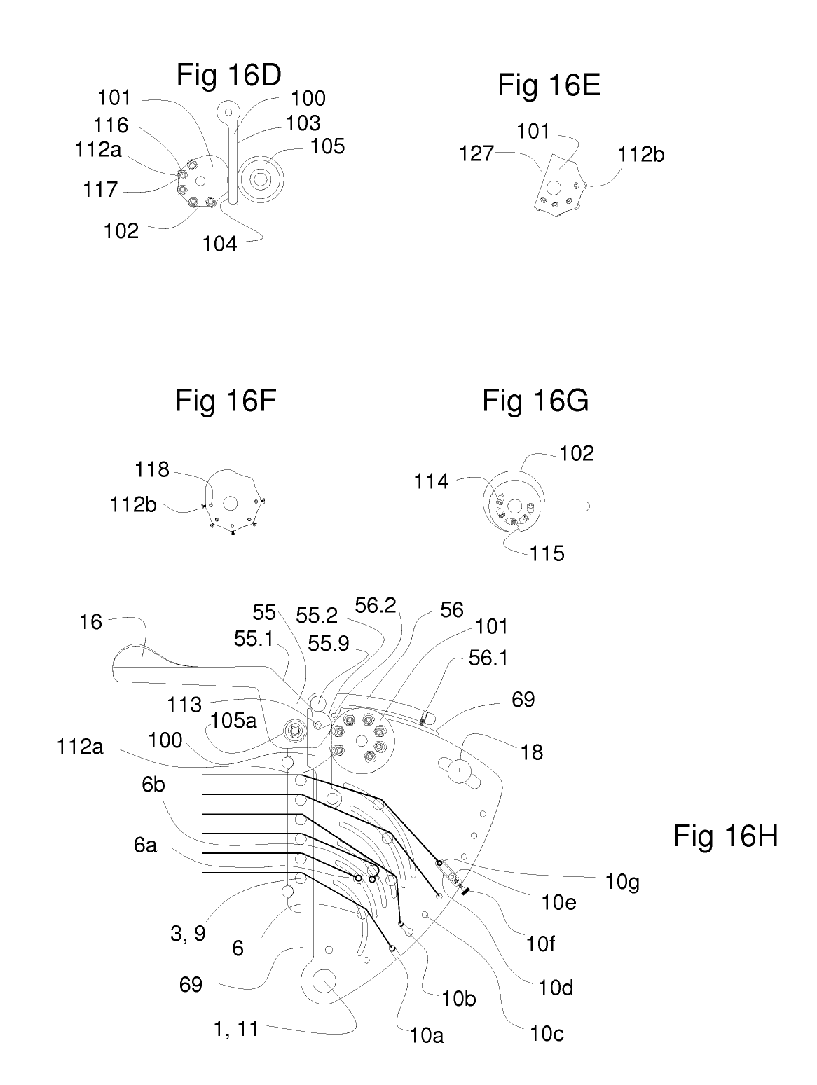

A main feature of the invention shown in FIGS. 3 and 4 is a pivoting main vibrato member 8 (a moveable tail piece) holding in fixed relation to each other a group of string anchors 10, and optionally a separate group of string guides 6. The guides are preferably cylindrical string rollers or posts with axes parallel to the pivot axis 1 of the main member, but may be any shape or construction which serves the purpose described, and the string anchors themselves may be incorporated into the guides, as illustrated in FIGS. 3B and 8A, and 16H. The radius of the guide preferably reduces the cyclic bending stress at the string anchor due to motion of the vibrato mechanism. Anchor and guide means, particularly for the heavier wound strings, preferably include means to limit residual bending stress, which stress can deflect strings to sharpen string tone during extreme dives. Said means may include gentle radii on anchor holes 10a, 10b, or 10c or pivoting anchors or fine tuners 10c, or anchor pivot post 6a built into the guide, in FIG. 16H.

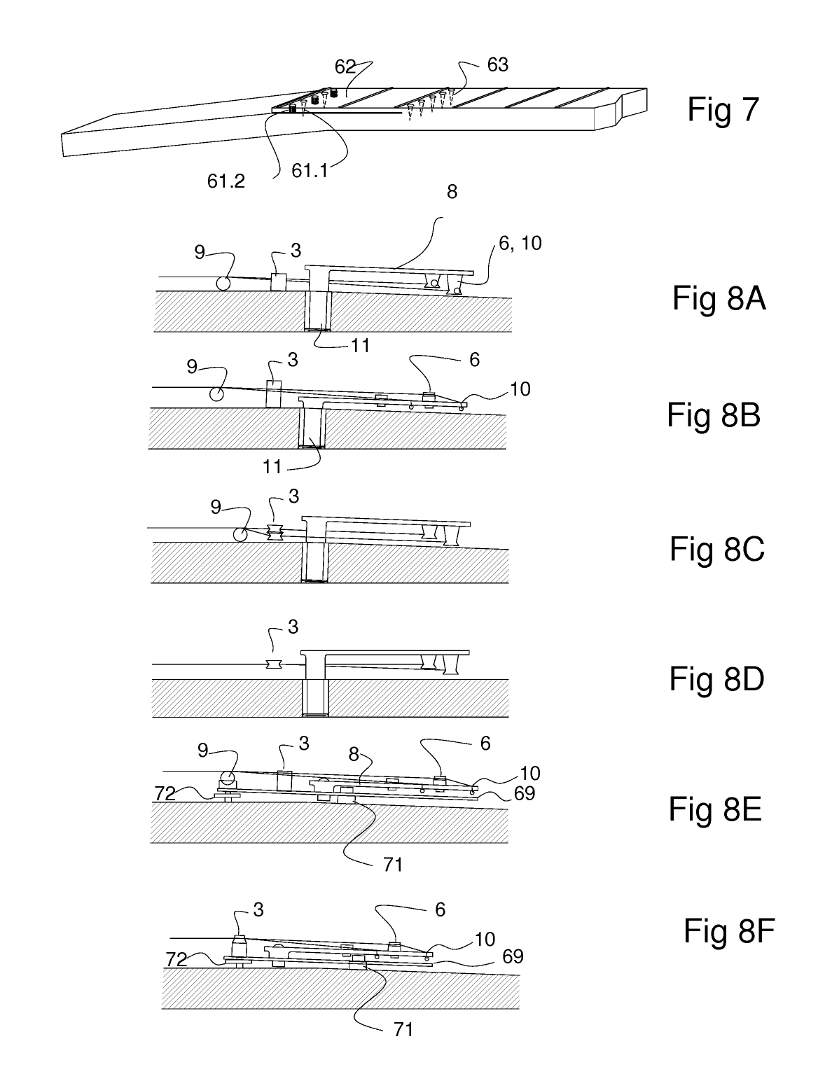

String bearing means 3, providing for a preferably slight change of string direction, may serve as the bridge 9, supporting one playable end of the string, as in FIGS. 3 and 8F Alternatively as in FIGS. 4A and 8A, bridge means 9, separate from string bearing means 3, may be employed.

Either the guides or the string bearing means may be notched or contoured to constrain the string axially, as illustrated in FIGS. 8C and 8D. Of additional benefit, notches shaped to support the circumference of the string cross section will reduce overall stresses on the string under tension.

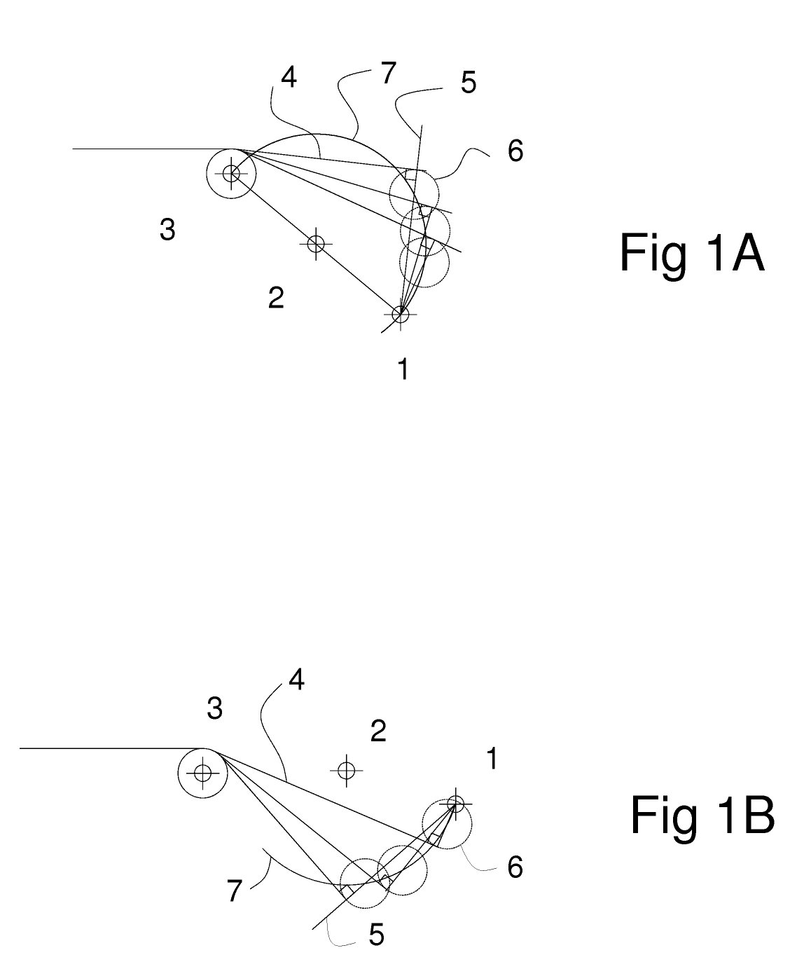

Referring to FIG. 1A, the guides 6 are preferably positioned on the main member so that, at rest, any line 5 radiating from the pivot axis 1 to the center of curvature of any string's guide surface 6 will intersect the suspended string axis 4 at a substantially right angle. That angle is assured at rest, regardless of adjustment, by constraining the guides to an arcuate path 7, and fixed with respect to said main rotating member. The arc for any such arcuate path may be constructed through the centers of any three cylindrical guide surfaces meeting the foregoing requirement, as shown in FIGS. 1A and 1B.

If the guide surface radius is identical to the string bearing radius, and if the strings are routed to the outer surface of both string guide and string bearing, then the arc will pass through both the bearing axis and the main center of rotation, and be centered on the mid chord 2 between those two axes when the device is at rest, as shown in FIG. 1A. Path may be modified to account for effect of wrap angle around guide means 6 and bearing means 3 on string path length.

Rotating the main member about its pivot axis 1 tangentially displaces the string contact point of each guide a distance proportional to its radius from the pivot axis 1.

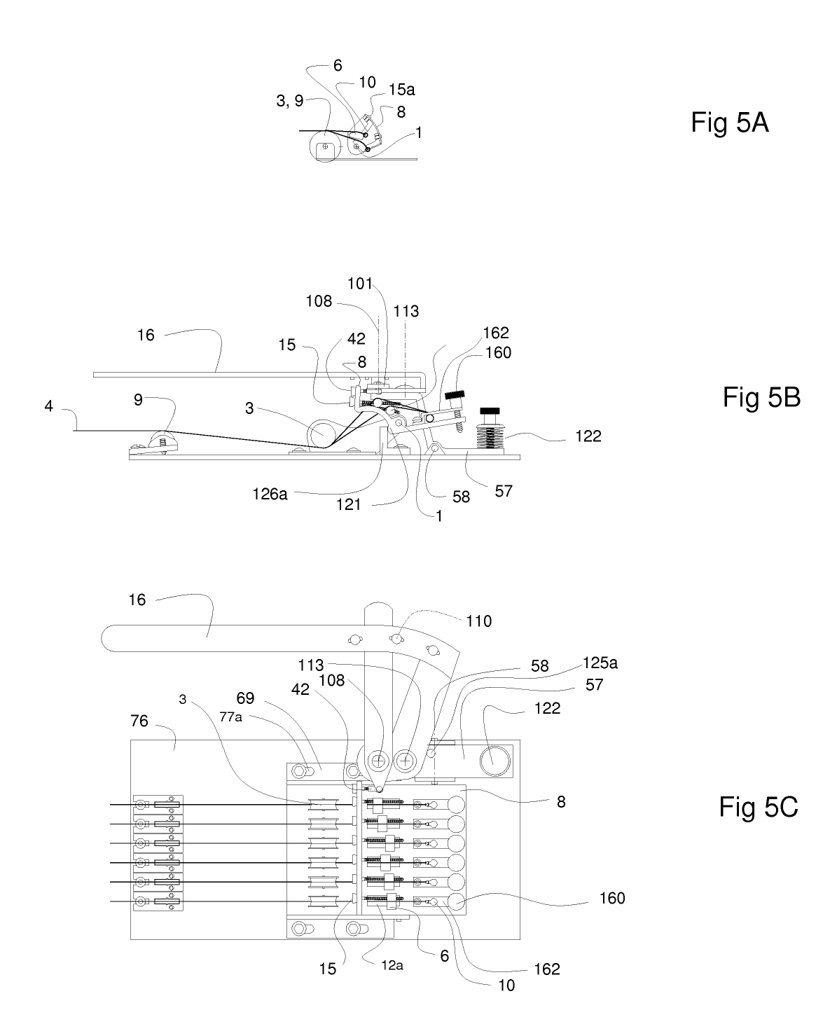

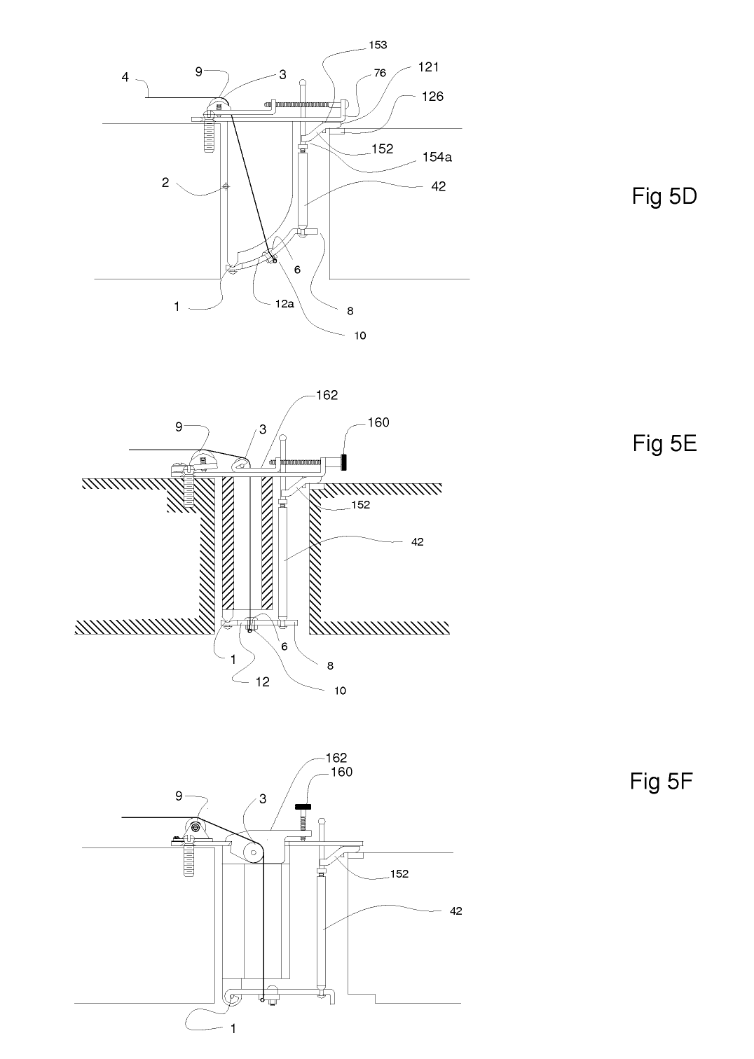

The guides 6 may be constrained to the arcuate path, for example, by means of arcuate slots 12 (fitted with t-bolts or t-nuts, for example) or rails on a flat plate as in FIG. 4, or by crank arms 13 as in FIGS. 3A and 3B, rotationally adjustable about guide path axis 2 fixed with relation to the main member, preferably resting on journal means for instance a shaft in FIG. 3C, or knife edge in FIG. 3A) with center of curvature at guide path axis 2, with axis means preferably slotted to allow string clearance during extreme bends. Said clearance may also be provided by suspending guide means 6 within an arcuate track means (for example slots in an arcuate plate 8 in FIG. 5A) or external to arcute plate means 8 in FIG. 5B.

The crank arm configuration of FIG. 3A has the benefit of allowing the guide for any string to be positioned with the string axis 4 near the main pivot axis 1, such that rotating the main member 8 about its axis will have minimal effect on that string's tension. That feature may be achieved in the flat plate example by anchoring that string to the body of the instrument, or to the center of the rotating member 8. Having pivot axis 1 parallel to the bridge, as in FIGS. 3A and 3B eliminates conflict between strings, which conflict may be avoided on the plate mechanism of FIG. 8 by differential string height from plate 8, or simply ignored.

Rotating member 8 preferably has torsion resisting member 74 between opposed endplates, as in FIG. 3B, or torsion resisting shell structure.

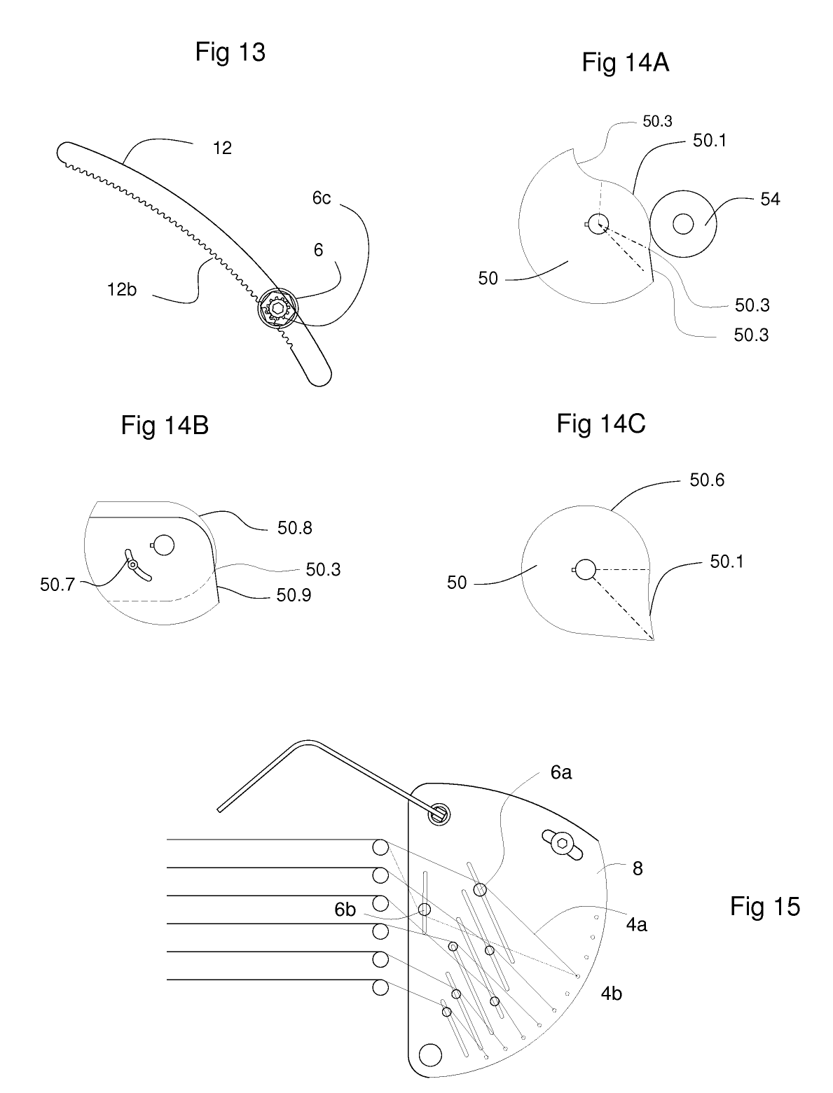

Adjustment of guide position along the arc in either configuration may be by linear adjusting screw 15, an example of which is pictured in FIGS. 3A, 3B, 5B, and 5C. Alternatively, the guides on a flat plate configuration may be manually positioned, or may have an adjustment aid in the form of a wrenchable pinion gear 6c preferably concentric with a string guide 6, engaging teeth 12b, preferably cut into the edge of the arcuate slot 12, as in FIG. 13.

Having anchor means 10 properly separated from guide means 6, and correctly configured, as in FIG. 3A maintains constant direction of force on crank arms 13, eliminating need for precision in component manufacture, and allowing adjustment by a simple unidirectional set screw, and allowing separate fine tuning mechanism 162 and screw 160, as in FIG. 5B.

A plate (which may be flat, contoured, or ribbed, for example) rotating about an axis substantially perpendicular to a plane defined by the strings anchored thereto, as in FIG. 4, may be rigidly cantilevered from a rigid pivot shaft 11 in rigid bearing means, as in FIG. 8A. Or, for example, it may pivot nonrigidly about a pin bearing 11, constrained to a fixed plane by separate bearing means about its perimeter, for example one or more shafts 18 extending through one or more arcuate slots in the plate as in FIGS. 4B and 4C, having bearing surfaces resisting axial motion of said plate.

Graded markings 165, on said plate means, radially spaced from pivot axis 1, as in FIG. 4A, allow quick setup according to prior records. Additional guides may be positioned for alternate tunings, allowing quick change between tunings without adjustment.

The plate may be made of any material or mass, depending on desired properties, and the mass may be augmented by addition of weights, attached preferably by screw means to the unexposed face of plate. Rigid flat opposing washer means on guide and anchor means, and optionally on additional stiffening screws, in contact with preferably ground flat plate surfaces, may enhance the stiffness of a thin plate by reducing flex at arcuate slots.

In an alternative embodiment of the invention shown in FIGS. 5B, 5C, and 5D, the said arcuate path comprises track means or slots 12a in rotating member 8 rotating about an axis 1 parallel to the string plane, wherein the rotating member 8 preferably comprises straight slots cut into a curved cylindrical surface plate. Where the guides 6 and anchors 10 are combined in FIG. 5D, Anchors separate from guides (as shown in FIGS. 5B and 5C) may be substituted to prevent the stiffness of the ball end lashing from affecting tune. Alternatively, the ball cup may be designed to allow the ball itself to pivot with low friction to maintain string alignment with low stress.

An alternative means of achieving tangential guide contact with strings is by the advantageous fixed or adjustable positioning of string bearing means 3, as shown in FIGS. 5E and 5F so that string contact with guide means is tangential (or at a common angle from trangency) with respect to rotation axis 1. Rotating member 8 is preferably a flat plate having straight slots 12 parallel to string plane, with string guide means 6 (preferably attached to anchor means 10) adjustably positioned in said slot. Pivoting (FIG. 5F) or sliding (FIG. 5E) fine tuning member 162 allows fine tuning without substantially defeating relative pitch correction during vibrato use. Fine tuning adjustment screw 160 on fine tuning member 162 doubles as means to position bearing means 3 for tangential string contact at guide 6.

Ball Crank Alternative

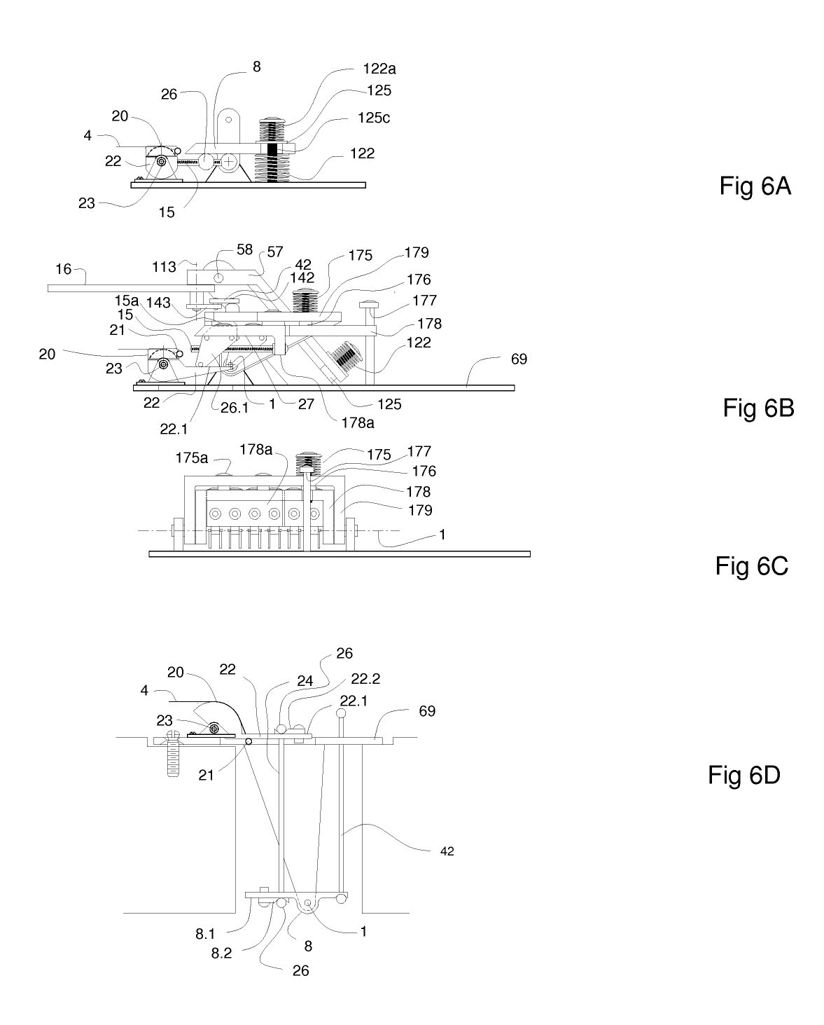

An alternative mechanism displayed in FIGS. 6A-6D comprises for each string, string bearing surface 20 (which may serve as a bridge or may direct strings to the bridge), and string anchor means 21 (preferably in the form of ball cups), fixed or adjustably attached to ball crank means 22, which pivot about a “ball crank axis” 23 preferably parallel to said string plane.

Actuator crank means 8 rigidly supports a group of preferably cylindrical or spherical actuator surfaces 26, preferably adjustable through a path substantially parallel to said force receiving surface 22.1 and essentially perpendicular to said ball crank axis 23.

An arm on each said ball crank includes a force receiving surface 22.1 oriented substantially parallel to a plane extending radially from and parallel to said ball crank axis, and separated from said plane by the radius of said actuators 26. Said surface 22.1 is preferably substantially parallel to the plane of strings.

When configured as a bridge, said string bearing surface 20, preferably substantially arcuate about ball crank axis 23, preferably includes vertical adjusting means providing for movement of bridge surface 9 in a direction normal to the plane of the strings 4 for adjustment of string “action”. For example, set screw means 14 and alignment pin means 14a.

Adjustment of actuators is preferably from a line coaxial with the main axis of rotation 1, in a direction toward or away from the ball crank axis 23. That single adjustment affects both the effective length of the acuator crank arm and the effective length of the ball crank arm, thereby determining the displacement of the string anchors 21 when control arm 16 is moved. Adjustment means may be, for example, by linear adjusting screws 15 in FIG. 6A, or by other means using locking screws 15a, as in FIGS. 6C and 6D.

The location of bridge pivot support 28 is preferably adjustable in a direction parallel to the strings. Intonation adjustment lock means 28 (preferably locking screw means extending through a slot in pivot support) locks support 28 in place after positioning. The sliding of support 28 is preferably constrained to the by linear track means.

Actuator 26 may be cantilevered from rotating member 8 or crank 22 on screw shaft 15, as in FIG. 6a, or it may extend between opposed surface 8.1 on rotating member 8 and 22.1 on ball crank 22, as in 6b and 6c. Alternatively, as in FIG. 6d, ball- or pin-ended tierod means 24 may extend between preferably parallel main member surface 8.1 and ball crank surface 22.1, constrained by positionable pivot anchors 8.2 and 22.2 on each end.

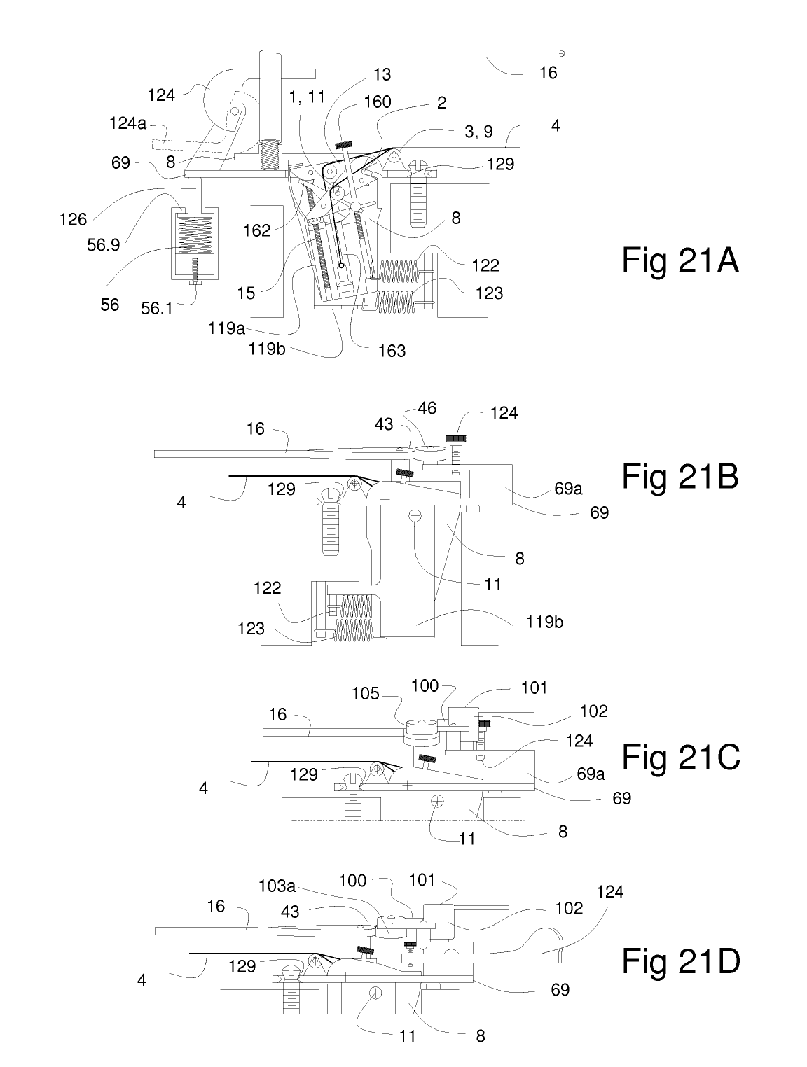

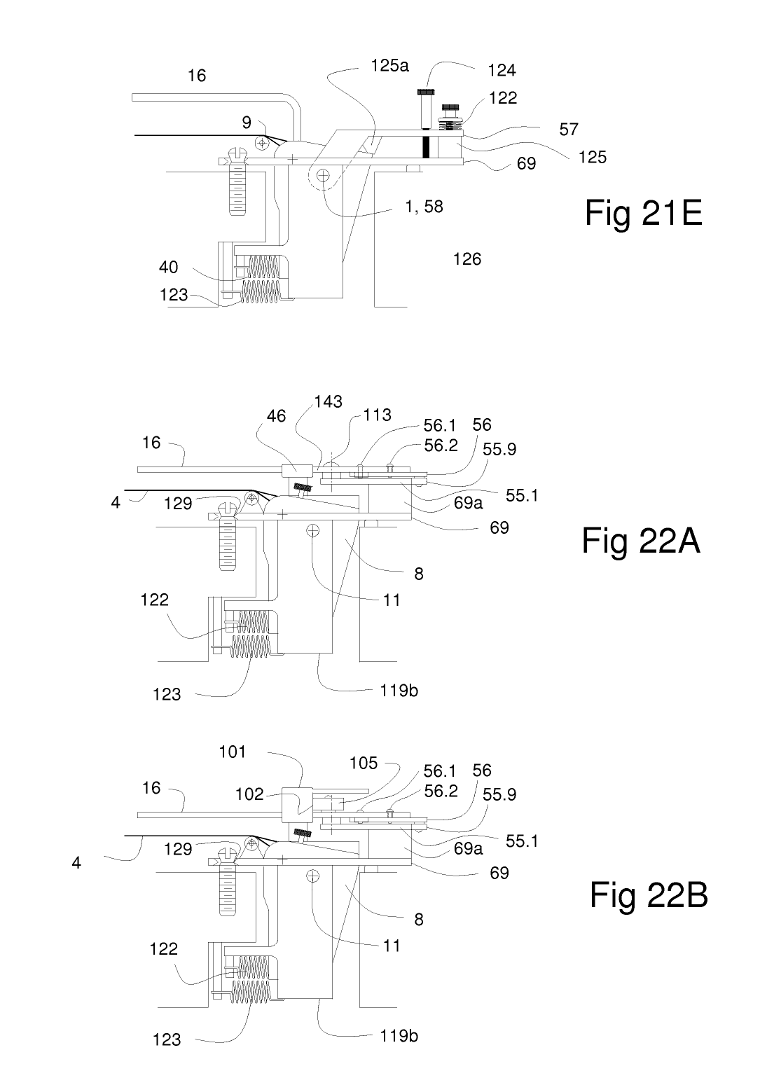

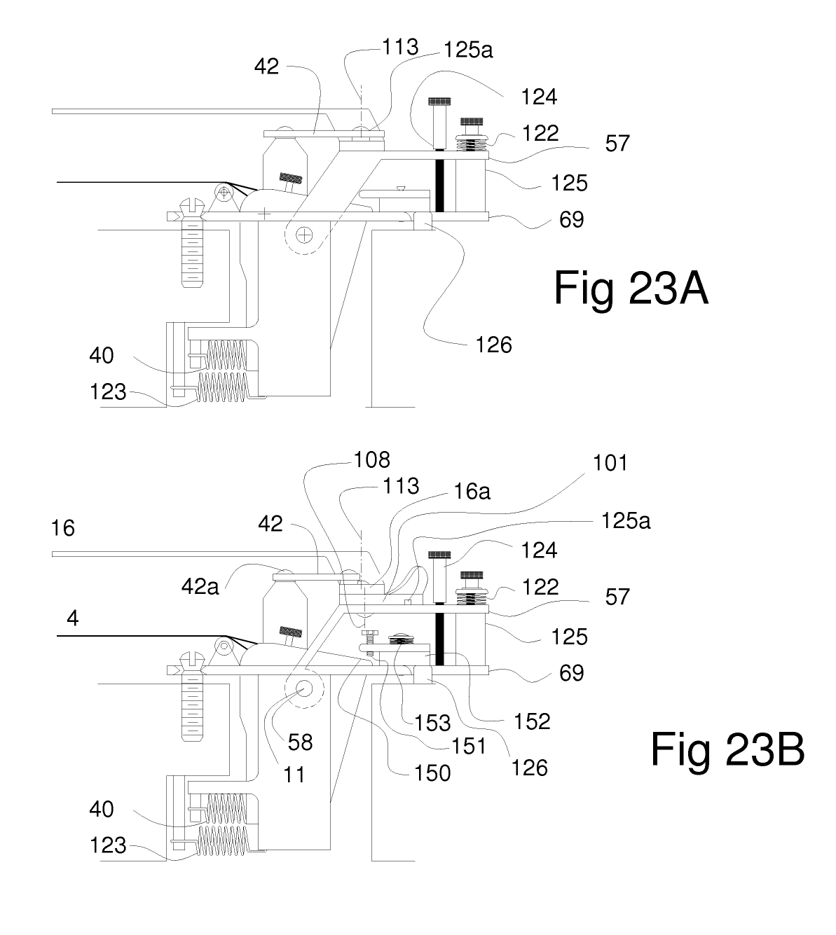

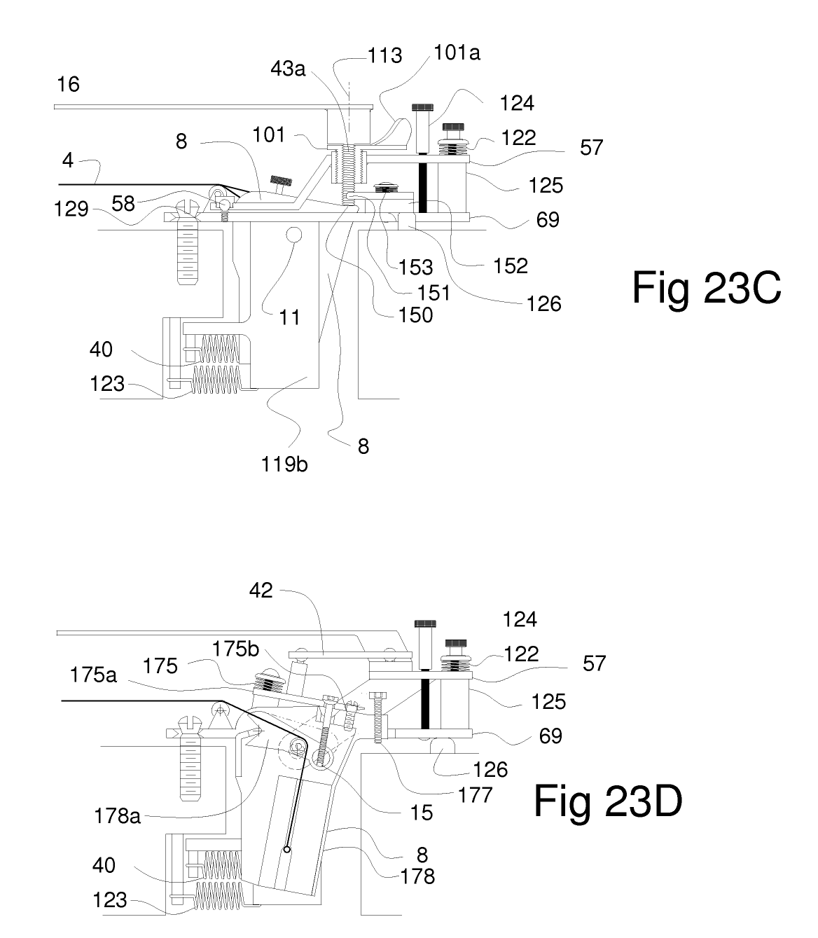

The control bar 16 may engage the main rotating member 8 directly, as in FIG. 3A, as is common among standard vibrato devices, or it may engage the main rotating member through mechanical linkage, for example linkarms 42 as in FIG. 5B, or cam means 43 as in FIG. 21B, or by screw means 43a in FIG. 23C, or by eccentric or crank or rocker means, 16a in FIG. 16A in order to achieve a desired purchase or direction of effort applied to the rotating member 8 for stretching or relaxing strings, or stability against drift and rebound.

Cam Operation

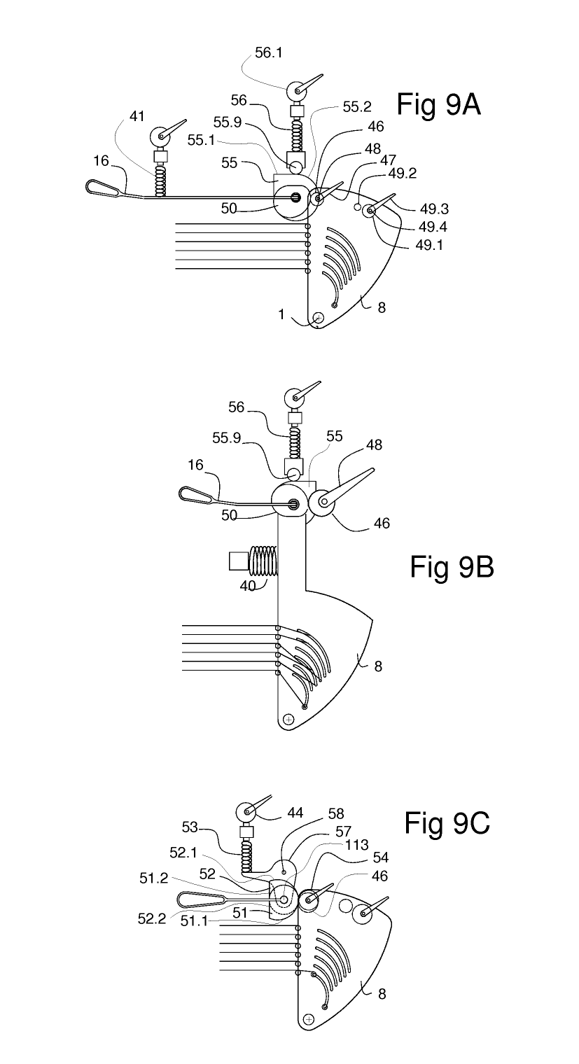

A preferred cam configuration shown schematically in FIG. 9A utilizes cam means 50, preferably on an axis perpendicular to the plane of the strings, the force of said cam opposing the tension of the strings by acting on a cam follower 46. Said cam has a primary surface preferably of progressively increasing radius 50.1, with no flats or constant radius portions in the operational portion. Cam may have a transition point 50.3 to a higher slope to provide tactile feedback when strings are “bent” a tonal half step, as shown in FIG. 14A. Two cams may be stacked axially to provide the same effect with adjustment means 50.7, as shown in FIG. 14B.

Actuator cam means intended for use in both bend and dive operations are preferably implemented in combination with separate means to return arm means 16 to neutral position when released, so that cam shape does not need to be compromised to serve that purpose.

The position of cam follower means 46, which position determines resting pitch, is preferably adjustable, for example by lever means 47, acting on an eccentric shaft or crank.

With string tension on main member 8 pressing cam follower 46 into first cam 50, this first cam means creates increasing pitch when rotated in one direction from the rest and decreasing pitch when rotated in the other.

To allow arm 16 to be swung out of playing position when not in use, cam may be cut with a large angle of constant radius, and secondary angle of increasing radius.

Mutliple Springs

A combination of 2 or more springs may be used advantageously. The first spring (a balancing spring 40) is preferably adjustable, and preferably acts on the main rotating member, opposing the tension of the strings, in order to reduce the effort required for the user to perform harmonic bend actions. Adjustment of said balancing spring will determine the amount of effort required to move rotating member 8 away from home position. Balancing spring 40 may be used in conjunction with arm biasing spring 53 of FIG. 9C to further define the effort required in dive and bend actions, and to reduce load on adjustable spring components.

One or more secondary springs 41 in FIG. 9A acting on the control arm 16 or on cams or linkage attached thereto compensate for string and first spring forces.

One or more third spring means may act on the arm or on detents to assist in forcing the arm 16 into or out of adjustable detents for selecting alternative arm positions in a less preferred embodiment.

Said spring or springs may be adjusted to optionally completely balance the string tension at base tuning, or to merely reduce the effort required by user to move device off of a biased home position.

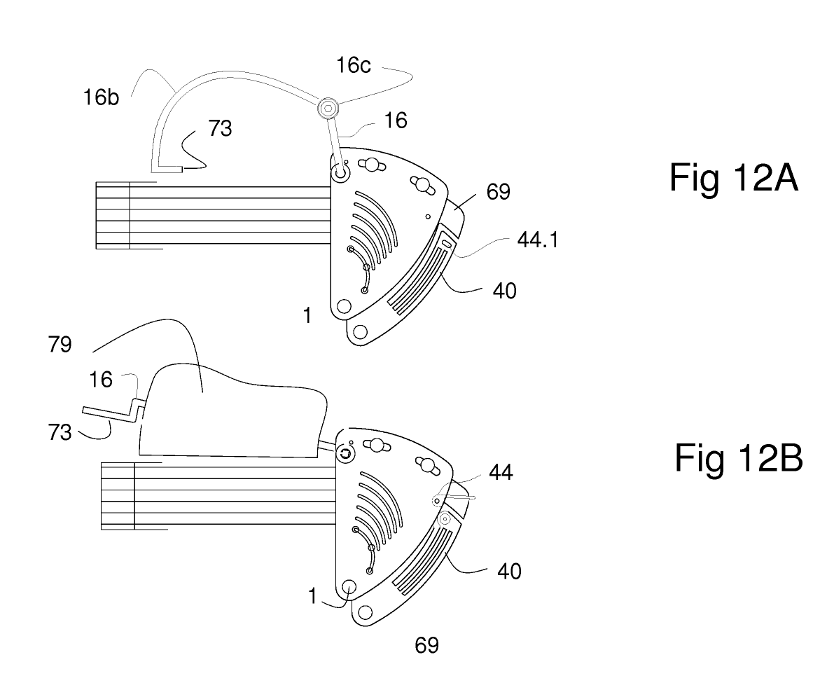

Note that, while coil springs are generally depicted here for schematic purposes, it is anticipated that any spring configuration fitting the application may be applied. In FIGS. 12A and 12B, a base plate 69 may be of spring steel material having a cantilevered balancing spring 40 cut into said plate and preferably rigidly or pivotably linked to rotating member 8, or adjustably linked, for example by cam 44 means.

Return Spring Cam

A benefit of the present invention relates to full floating vibrato embodiments, where a return spring forcing a cam follower against a return cam provides accurate neutral positioning without adversely affecting the motion of the control arm. The spring may act alone, or it may preferably be aided by additional balancing or bias springs acting directly on the control arm or the main rotating member. It may act directly on the main rotating member, or through the control arm.

In FIGS. 9A, and 16A, 16B, and 16H, return spring means 56 urges return cam follower 55.9 against return cam 55, having a primary motion-resisting return surface 55.1 of high or graduated slope, and preferably a secondary surface 55.2 of lower slope (or constant radius). Spring force is preferably adjustable, for example by set screw 56.1 (in FIGS. 16A and 16H) or by eccentric cam means 56.1 shown schematically in FIG. 9A.

Alternatively, spring 56 and cam follower 55.9 may rest on stop means 56.8 (optionally having adjusting means 55.9) when not engaging primary return surface 55.1, as shown in FIG. 16B. Where travel of said cam follower is limited by said stop means, the return cam and cam follower surfaces may meet at any angle, including normal to rotation direction, wherein they engage as a simple biased stop, and said secondary surface of zero slope 55.2 is unnecessary.

Another embodiment of said stop is further illustrated FIG. 21E. Here stop 125a on transport means 57 resists rotation of main member 8 with the force of preferably adjustable dive bias spring 122. Member 8 may be further biased separately by separate balancing spring 40.

In FIGS. 9A, 16a, and 16H, the force of cam 50 on cam follower 46 opposes the effect of string tension on the device.

In an alternative configuration shown conceptually in FIG. 9B, balancing spring 40 is energized to exert force adequate to stretch the strings to their highest allowable pitch, and the force of main control cam 50, upon main cam follower 46 opposes the biasing force of spring 40. When control arm 16 rotates to reduce its force between cam 50 and cam follower 46, the balancing spring 40 moves the main rotating member to increase the tension on the strings. Return spring 56, preferably urging return cam 55 and return cam follower 55.9 together, opposes the bend generating rotation of the control arm 16 and returns it to neutral position when it is released. The benefit of this configuration is that a broken string will have no effect on the pitch of the remaining strings or the as might another configuration if the force on balancing spring 40 were excessive.

Note that return cam 55 may rotate with control arm 16, while return spring 56 is substantially stationary (see FIG. 16H), or the cam may be relatively fixed (to base 69 or rotating member 8), while return spring 56 and cam follower 55.9 rotate with arm 16, as in FIG. 16A.

In FIG. 9A, a counter spring 41 may maintain string tension alternatively by engaging the control bar 16, rather than acting directly on the rotating member 8, thus eliminating any backlash effect of imprecision in control linkage.

Said counterspring or “balancing spring” force at rest is preferably adjustable using cam means 44, or other means.

A sharpening cam cut with a long constant radius surface at its root allows arm 16 to be swing away from stings when not in use. Another advantage is that overshooting the root when returning from a bend will have no effect on string pitch as with other devices (unless the cam is specially cut for that effect, for example)

Transition From Dive to Bend

Dives generated by pressing the control arm toward the instrument body may include a dive transport mechanism 57 rotating on axis 58 substantially parallel to bridge means or string plane, as in FIG. 21E.

In a simple embodiment, shown in FIG. 21E, a control arm 16, directly engaging main rotating member 8, allows the user to generate a bend by pulling upward on arm 16, as is common in the art. When released, string forces return the unit to neutral position, where it rests on stop 125a, fixed relative to harmonic dive transport 57. Pressing arm 16 toward instrument body lifts dive transport 57 from its rest position, biased against dive bias stop 125 by harmonic bias spring means 122.

Dual Action Transport

A second preferred cam configuration in FIG. 9C utilizes separate mechanical means for bend and dive operations. Arm 16, engaging two separate actuation means (for example bend cam 51 and dive cam 52) rotates on axis 113, fixed relative to transport means 57.

In the schematic example, a first cam means 51 has a rest surface 51.2 of constant radius over much of its useable circumference, and sharpening surface means 51.1 of increasing radius.

With string tension on main member 8 pressing cam follower 46 into first cam 51, this first cam means creates increasing pitch when rotated from the root 50.0 in the direction of increasing radius, and no tonal change when moved in the other. Cam means 51 may include the features of upper cam means 50.9.

A flattening cam 52 has an optional rest surface 52.2 of constant radius and a flattening surface 52.1 of increasing radius extending from the meeting of two surfaces at root 52.0

A biasing spring means 53, acting directly or indirectly on transport means 57 pivoting on axis 58, biases cam surface 52.2 against stop 54, thus locating cam 51 at “home position”.

Said biasing spring 53 (preferably combined with other spring means) is preferably of adequate spring rate and deflection to maintain force against stop 54 during normal harmonic bends generated by the force of cam 51 on follower 46.

Preferably, rotating control arm 16 in a second direction progressively reduces string pitch by engaging stop 54 with the flattening surface of increasing radius 52.1, thus moving flattening transport means 57, and thereby moving first cam 51 away from “home” position, allowing follower 46 to follow.

The dual action cam, while illustrated with its axis normal to the string plane, may be equally applied to a device with control arm axis or main member axis parallel to the string plane, and is applicable to both harmonic and standard vibrato configurations.

Dual Axis Operation

In the preferred embodiment, said second direction of rotation of control arm 16 is in a different plane (preferably at right angles) from that used to sharpen string tone.

In the preferred embodiment, harmonic bends are implemented by rotating control arm 16 on an axis 113 substantially normal to the sting plane (when at rest), and fixed relative to dive transport 57, as in FIG. 20A, where simple linkage 42 connects main rotating member 8 to crank 16a (engaged by control arm 16). Crank may rest with link aligned with arm axis 113, or it may rely on stop means 125a to create a more mechanically advantageous rest position.

Arm 16 may optionally rotate freely on crank 16a until engaged by crank means 16a, for example via stop pin 141, or the arm and crank may preferably be combined into a single component.

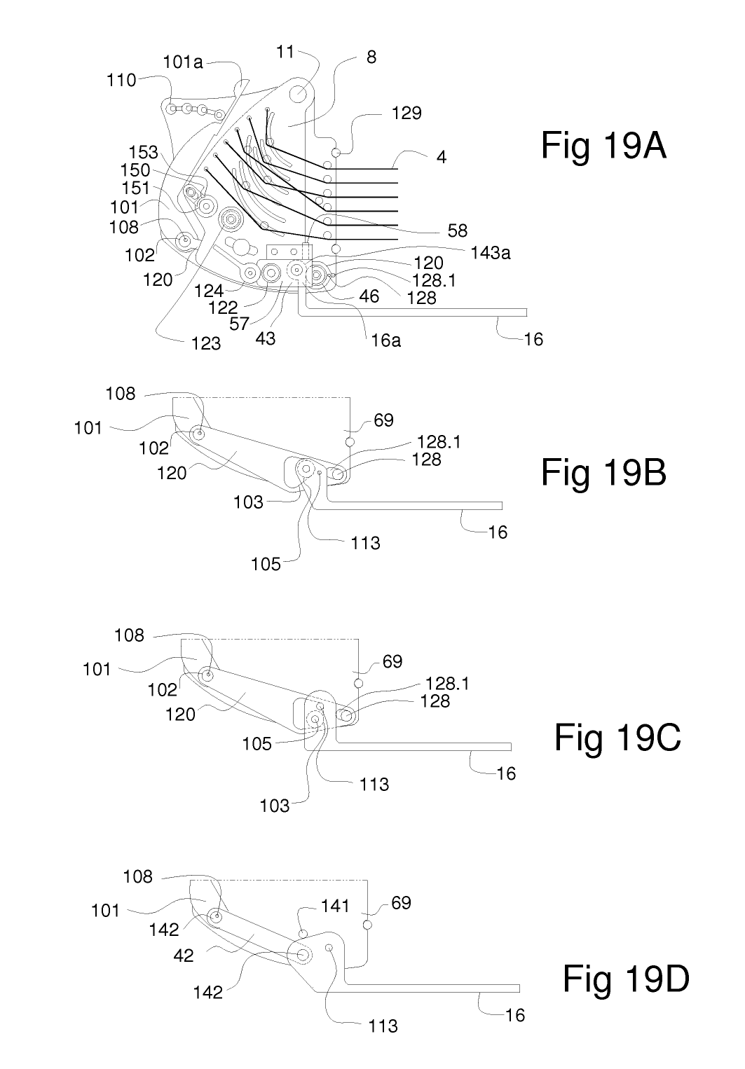

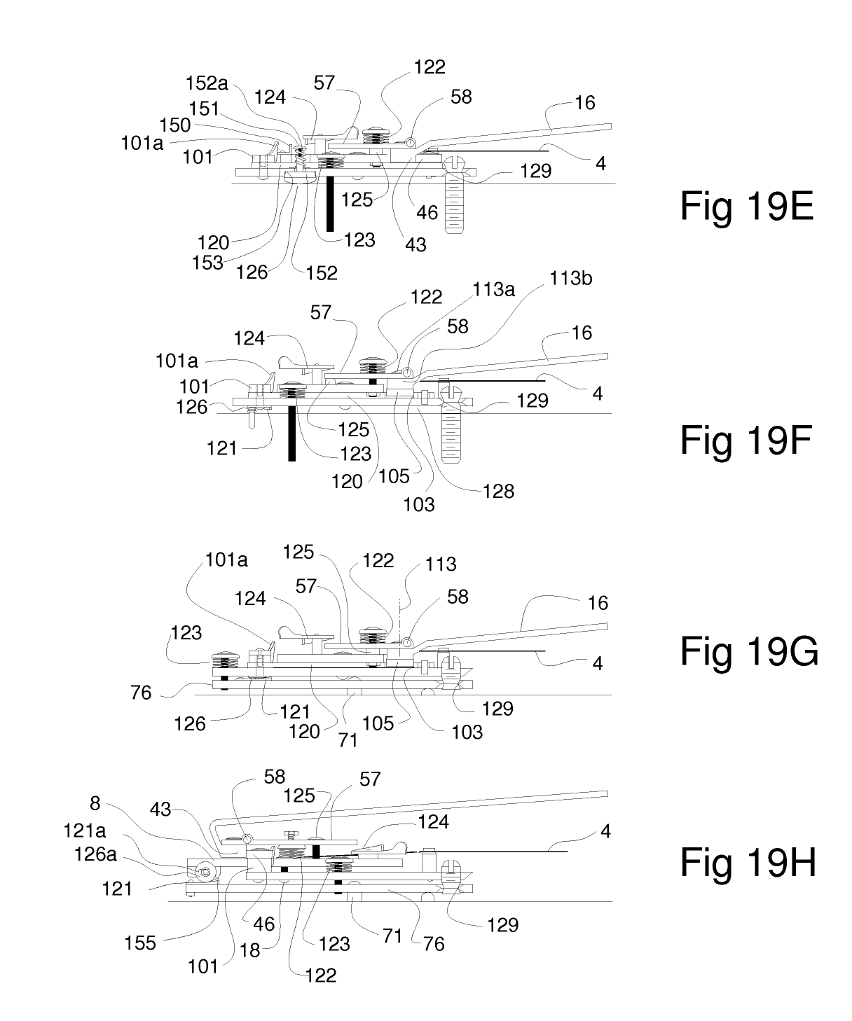

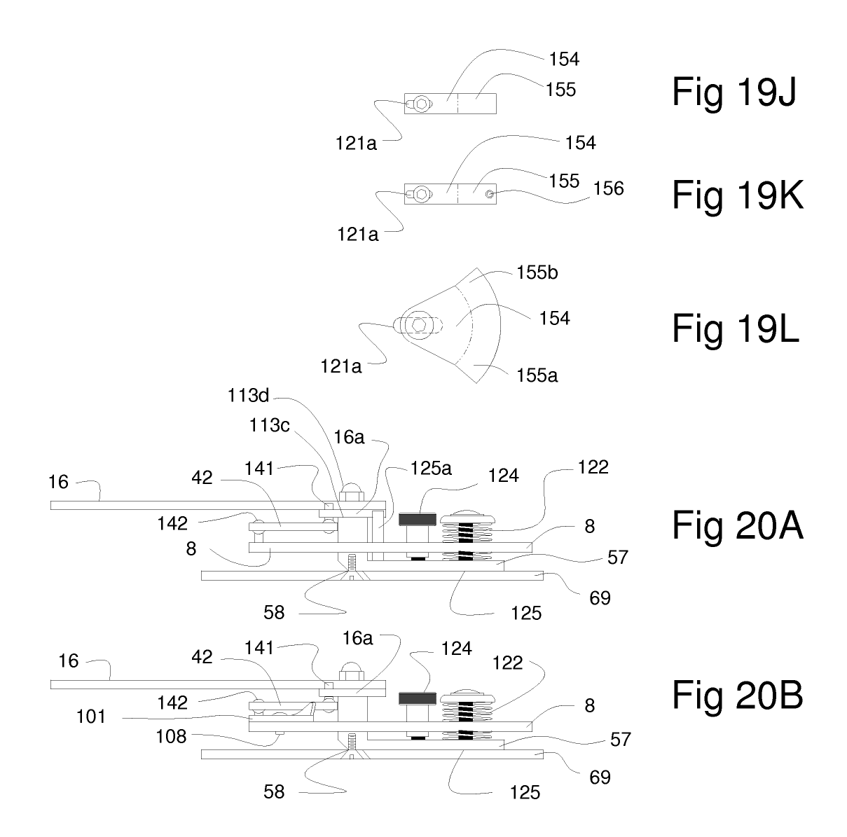

Control arm axis 113 is preferably fixed relative to transport means 57 by suitable means, for example rigid shaft and journal means 113a and 113b in FIG. 19F, or thrust bearing means 113c between arm, crank and transport means in FIG. 20A, compressed by shaft screw means 113d.

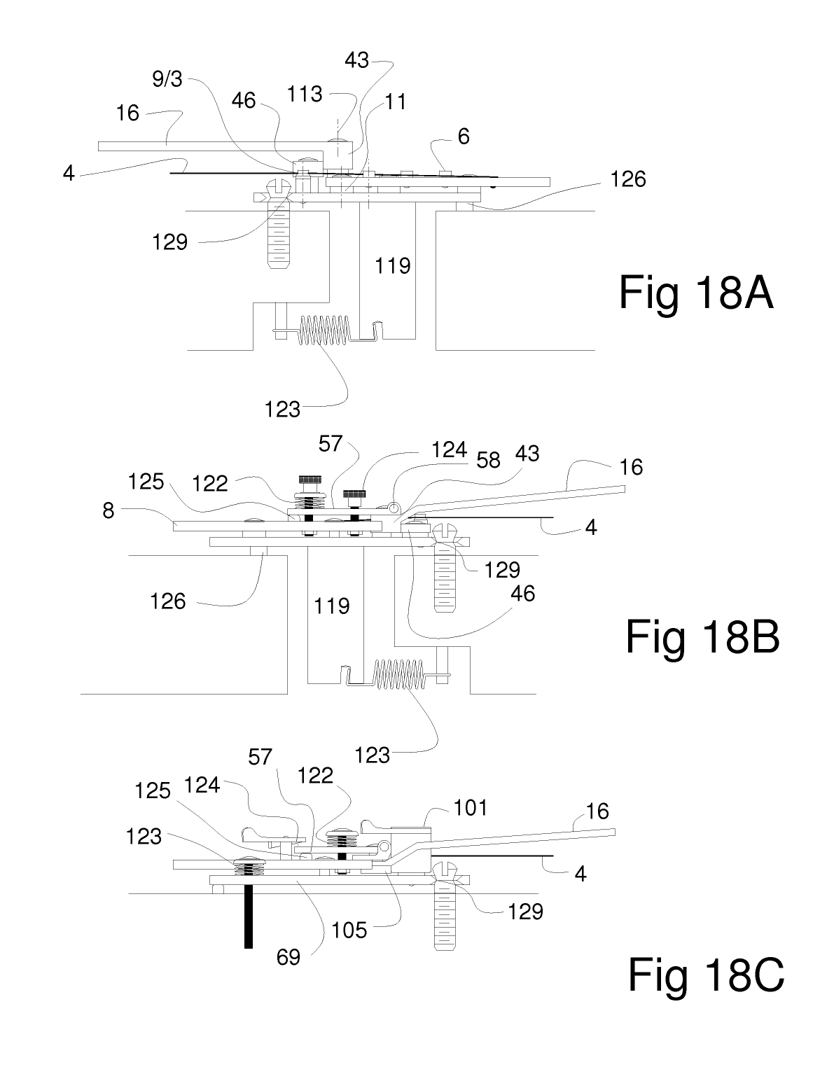

Transport rotation axis 58, preferably substantially parallel to said string plane, may be fixed relative to the instrument body (or base means 69) as in FIGS. 20A and 23A, or it may be fixed relative to main rotating member 8, as in FIG. 18B. Alternatively it may be fixed relative to bend axis 113.

The tensile linkage 42 shown in FIG. 20A is illustrative only, and not intended to limit the scope to the invention. Cam, screw, rocker, or any other suitable mechanical means may be used to similar effect.

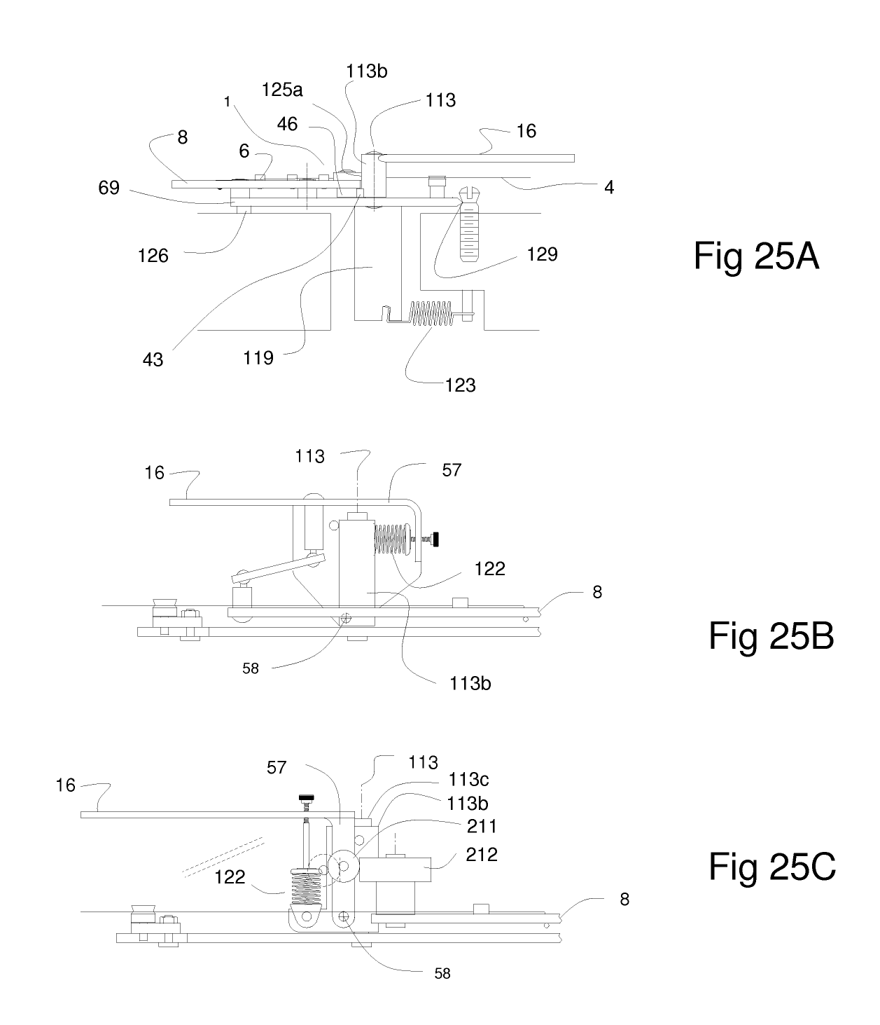

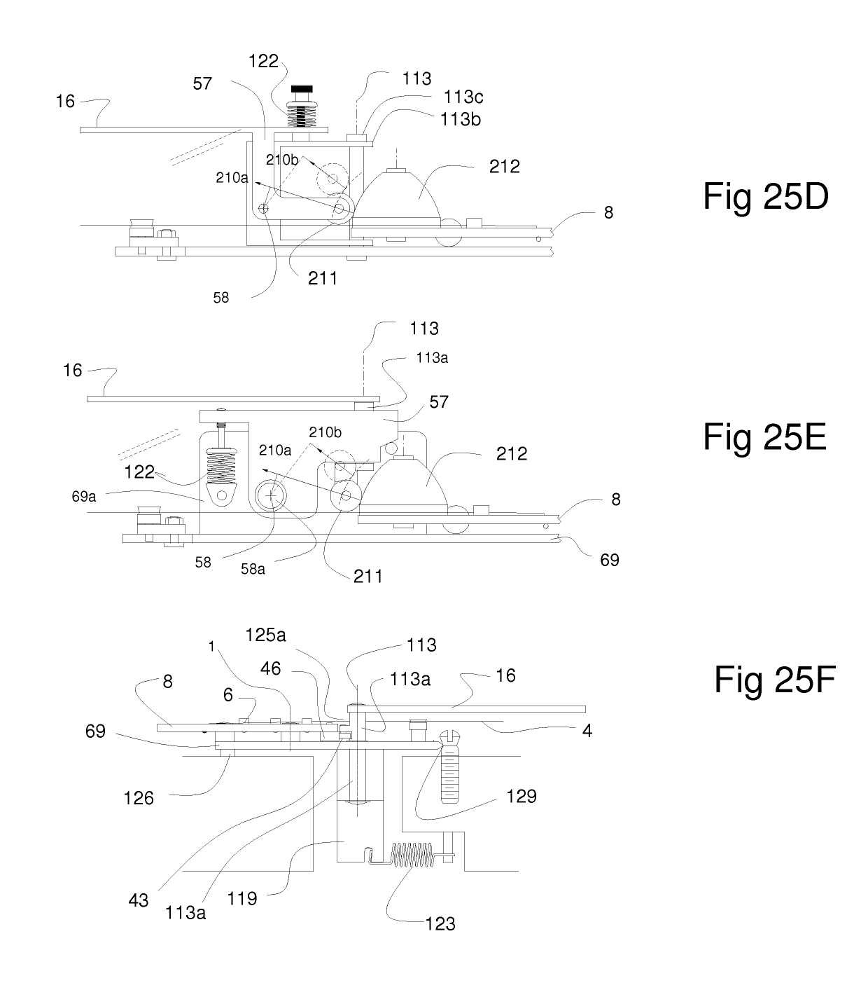

The dive transport may alternatively rotate on a shaft or journal centered on bend axis 113, and cantilevered rigidly relative to the base or body, as illustrated in FIGS. 25B-25E and discussed later.

Dual axis operation may alternatively be accomplished without said transport means as shown in FIGS. 21A, 21B, 21C, and 21D, Main rotating member 8 on main axis 1, substantially parallel to bridge means, is engaged by control arm 16 rotating on axis 113 obliquely fixed with respect to rotating member 8, at an angle that maintains arm height above instrument body as arm 16 rotates for a bend effect. Harmonic bias spring means 122 pulls rotating member 8 away from bridge means until stopped by cam 43, crank roller 105, or screw means 43a. Cam means 43 may be a simple radial cam as shown, or an axial cam or screw acting substantially tangentially.

Transition From Harmonic Dive to Standard Dive

The present invention allows incorporation of both standard dive and harmonic dive in single mechanism in two embodiments.

In simple embodiments, shown in FIGS. 18A, 16A, and 16H harmonic bends and dives are both accomplished by rotation of the control arm 16 about an axis normal to the string plane. The cam in FIG. 18A is preferably shaped so that counterclockwise motion (pulling the arm across the strings) causes a bend, while clockwise rotation causes a dive. The arm is preferably provided with return spring 56 and return cam means 55.1 as in FIG. 16A or 16H.

With the control arm shaft or journal rigidly mounted, (by way of direct mounting, or mounting though intermediate components) with respect to either the base plate 69 (FIGS. 16A-16H, 25A, 25F) or the main rotating member 8 (FIG. 18A-18C), rotation of arm toward the body causes a standard dive, preferably by tilting the base plate means 69 off of stop 126 in opposition to standard bias springs 123, toward the tuning head Alternatively said downward pressure may act through suitable means to slide the base plate 69 or rotating member 8, or pivot shaft 11 toward the head to reduce string tension.

In a preferred embodiment shown in FIG. 18B, pressing the arm 16 toward the body rotates a harmonic dive transport 57 from its bias stop 125, reducing string pitch harmonically until contact between transport 57 and (preferably adjustable) harmonic dive stop 124 locks transport 57 directly or indirectly to means causing a standard dive (preferably base plate 69). Further downward pressure on control arm 16 causes base 69 and bridge 9 to pivot in unison with said transport reducing length and scale length uniformly in all strings in a standard dive.

Alternatively, said transport may be hinged to base 69, as shown in FIG. 23A, where linkage 42 connects arm 16 to rotating member 8.

Where control arm 16 engages main rotating member 8 directly, as in FIGS. 21A, 21B, 21C, and 21D, dive stop 124 engages rotating member 8 directly with base 69 (or other means to generate standard dive)

Harmonic dive stop 124 may be configured as a simple thumb screw in FIGS. 18B and 23A, as axial cam means in FIG. 18C, or as radial cam means in FIG. 21A. Cam means may be continuous or stepped, and steps may be adjustable, for example by thumbscrew, as in FIG. 21C.

Both of these methods have the novel benefit of being able to combine a harmonic bend with a standard dive simultaneously, while the preferred embodiment allows a novel means of harmonic free float with a user selectable transition point from harmonic dive to standard dive.

Transposing

Transposing means to shift the key of instrument by one or more half-steps when the vibrato is in neutral position may be incorporated into the vibrato mechanism.

The following transposing means may be applied to any harmonic vibrato device to change “key” or the string pitch at neutral position.

Transposing means is preferably an indexable lever adapted to alter either the position of the control actuator device or the component engaged by the control actuator, relative to its mounting. If the latter, it may engage the control device directly, as with a cam or cam follower mounted to pivoting hub, or it may engage indirectly though an intermediate idler lever or idler link, or by simple rod linkage.

In a simple implementation shown in FIG. 16A, transposing handle 101a, preferably flexible parallel to its axis 108 (fixed relative to main rotating component 8), is held against any of several stops 110 preferably by string tension. Stops are preferably adjustable by eccentric rotation or by displacement within slot 111 or both.

In FIG. 16A, the transposing hub or transport means 101 includes cam or rocker surface means 102 engaging the actuator crank roller 105.

In FIGS. 16B, 16D, 16H, and 21C, an idler lever 100 between actuator roller 105 and transposing transport means reduces effect of transposing displacement on the at-rest position of control arm 16. Similarly a cam follower 103a in FIG. 21D mounted to idler lever 100 engages control arm cam 43.

Said transposing idler 100 includes opposing transposing surface means 104 and expressive surface means 103, each in force receiving engagement with transposing actuator surface means 102 and expressive actuator crank or crank roller 105 or cam. In FIG. 22c said expressive surface means 103 is on cam follower means 103a, the surface of which engages expressive actuator crank or cam surface 50.

An alternative embodiment in FIGS. 19A, 19B, 19C, and 19D includes idler link means 120 in tension between transposing transport 101 (pivoting on axis 108 fixed relative to base 69) and expressive actuator cam 43, or crank 16a, or crank roller means 105, with optional alignment means, for example a pin 128 in a slot 128.1.

In FIG. 20B, idler link 120, preferably with spherical or knife edge rod ends 142, extends from a transport crank 101 pivoting relative to main rotating member 8 to actuator crank arm 16a engaged by or fixed to control arm 16.

In FIGS. 5B and 5C, a simple pivoting link 42 extends from a transposing crank 101, pivoting relative to control arm 16, to main rotating member 8.

In FIG. 23B transposing transport means 101 includes crank means to displace control arm crank axis 113 relative to base 69 (and to harmonic dive transport 57.) Similarly, in FIG. 23C, where main control mechanism comprises axial cam or screw means 43a engaging rotating member 8, a preferably coaxial transposing screw device 101 displaces control mechanism axially relative to harmonic dive transport means 57.

Alternative transposing devices are illustrated in FIGS. 16B through 16F. In FIG. 16D transposing hub 101 is scalloped to create a lobed surface 102, wherein a chord between said lobes is normal to the radius. Optionally, eccentric lobe extension means 112a, preferably incorporating threaded studs 116 secured with locking nuts 117 allow precise tuning adjustment. String tension presses 2 lobes against surface 104 of idler 100 to provide, and 16G. Alternatively, FIGS. 16E and 16F include substantially radial lobe screw means 117, preferably secured with set screws threaded through hole 118 or jam screws accessible through hole 118.

In FIGS. 16B, 16C, and 16G, transposing transport 101 includes preferably smooth cam or eccentric surface 102, constrained by stop screws 114 having a substantially axial direction component in FIG. 16G or a substantially radial direction in FIGS. 16B and 16C. In FIGS. 16B and 16C, transport means 101 preferably is rotatable about shaft 107b, and preferably shaft extension 107a, having hold down means 109a. Preferably adjustment lever 101a pivoting on fulcrum 109 is available to lower and raise transport 101 on its shaft to engage and disengage fixed stop 115 from stop screws 114.

Transposing means may be positioned by separate handle means 101a as shown, or alternatively by intermittent latching engagement means with control arm 16, preferably where control axis 113 and transposing axis 108 coincide, as in FIG. 23C.

Idler link may alternatively comprise piston means compressed between transposing transport and main control crank or cam.

Transposing means preferably has adequate adjustability to allow detuning for instrument storage and string changes, for example by deep depression 127 in transposing cam means in FIG. 16E.

Flex Compensation

The performance of any transposing vibrato device will suffer during excursions over multiple tonal steps on a low-modulus instrument, because the effects of neck deflection are non-linear with respect to changes in string tension. An optional feature of the present invention compensates for neck flex and other nonlinear displacements by moving the base 69 carrying the string bearing means 3 (preferably coinciding with bridge 9)and main rotating component 8, slidingly or pivotably in the direction of headstock movement. Compensation means, in the form of a cam, wedge, crank, screw, or other means translate motion of the transposing transport 101, the actuator arm 16, or the main rotating member 8, into motion of the tailpiece or bridge assembly to adjust string tension in unison, preferably by adjusting the dimensions of standard bias stop means 126. (see FIG. 19)

In FIGS. 19F, 19G, screw, wedge, or cam, means 121, forcefully engaging standard bias stop 126, one of which components moves with transposing means 101, adjusts the position of bridge carrying base 69 with respect to said bias stop, and thereby compensates for neck flex resulting from transposing action by moving bridge means 9 toward headstock as transposer is tuned to lower pitch.

In FIG. 19H linear cam means 121 and cam follower means 126e, with relative positioning means (for example slot 121a) translate motion of main rotating member 8 into displacement of base 69. FIG. 19J, illustrates a face view of cam having primary (low slope) and secondary (high or progressive slope) surfaces 154 and 155, where the length of the primary surface is adjustable by slot means 121a. In FIG. 19K, the slope of secondary surface is adjustable by set screw means.

Cam 121 in FIGS. 19H and 19L has a range of secondary surface slopes available from low 155a to high 155b, selectable by angularly positioning the cam with respect to the path of the cam follower 126e.

Alternatively, the tailpiece 69 (preferably supporting rotating member 8 and string bearings 3) may be moved pivotingly or slidingly relative to the bridge 9 and headstock to adjust the stretch of all strings uniformly. In FIG. 5B, cam, crank, or rocker means 121 rotating with the main rotating member 8 relative to tailpiece 69 rests compressively on compensation stop means 126d. Cam surface shape, or the initial angle of crank is selected to displace tailipiece in a manner matching the nonlinear displacement in the instrument. Slots 77a (for example) allow tailpiece 69 to slide under string tension with respect to base 76.

Likewise in FIGS. 5D, 5E, and 5F, a moving component (for example linkage 42) acts on crank 152 pivoting on crank pivot 153 (in FIG. 5D). Nonlinearity may be enhanced by the shape of cam surface 121 on end of crank 152, or by a preferably adjustable initial gap 154a between moving component 42 and crank 152, or both.

Similarly in FIGS. 19A, 19E, 23A, 23B, and 23C, lifter means 150 on rotating member 8 engages rocker end 151 to rotate flex compensator crank means 152 about pivot 153.

In FIG. 19E, rocker end screw 151 adjusts axially to determine displacement of crank 152. The initial delay is adjustable by sliding or rotational positioning of lifter 150. Spring means 152a may also be employed to position crank 152.

In FIG. 23B, rocker end screw 151 adjusts the compensation delay, while the displacement rate may be set by positioning of stop 126 or pivot 153, or by adjusting the length or crank 152.

This method of flex compensation is suitable for any embodiment of the present invention, or any alternative transposing vibrato means, whether said bridge carrying base 69 moves angularly or slidingly with respect to instrument body, and whether the force bias on the bridge is toward or away from head stock.

The illustrations show cam and crank configurations where the rate of neck displacement diminishes with increasing pitch. By simple and obvious application of the same principles, the invention may be applied to instruments where the neck deflection rate increases with pitch. (for example by reversing the curvature of the compensating cam from that shown in the figures)

The above examples illustrate a flex compensation mechanism which opposes the force of standard bias springs (or complements string forces). By simple and obvious application of the same principles, cam means may alternatively be configured to oppose string tension, for example on a device having no standard dive bias springs.

Alternative or additional flex compensation may be provided by selecting and adjusting the rate and stroke of the harmonic and standard bias springs, so that force on the harmonic dive bias spring translates into a suitable displacement in the standard bias spring. Individual strings may also be biased.

The apparatus described will compensate for the sum of nonlinear tension effects, including neck, fastener, and hardware motion.

Similar compensation means applied to one or more individual strings may compensate for nonlinearities in the stress-strain curves of music wire.

To prevent or reduce hysteresis in the neck flexibility, truss rod cavity is preferably lubricated or fitted with low friction surface or rollers. Truss rod bow is preferably minimized to reduce friction forces acting thereon.

Electronic Vibrato

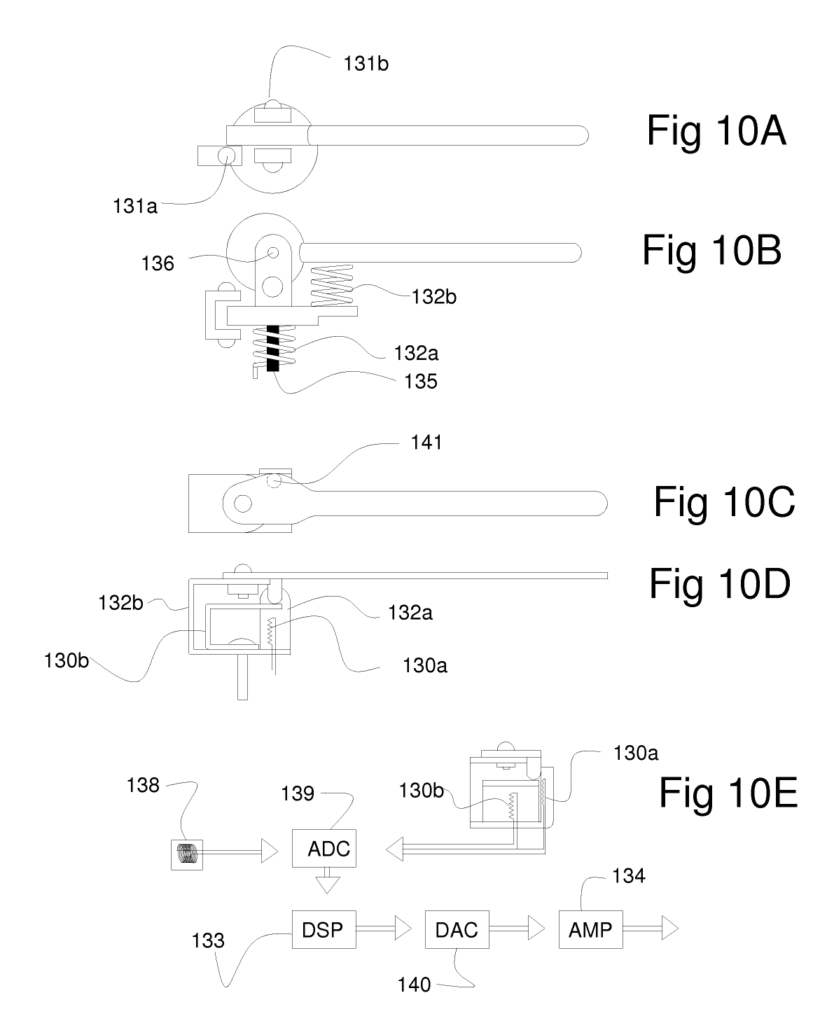

An electronic embodiment of the control means of the present invention, shown schematically in FIGS. 10 through 10D, provides an arm 16 rotatable about one or two axes 135 and 136 with respect to a mounting fixture, with rotation resisted by spring means 132a and 132b, and force sensors 130 or position sensors 131 measuring rotation in each free axis. Sensors may be of any type, for example piezoelectric, strain gage, inductive, magnetic, or capacitive sensors, and may generate analog voltage, analog current, digital, or frequency signals. (Analog is preferred for this discussion)

Analog or digital signal processing means 133 uses the signal from said sensors to proportionally modify the pitch of the signal from the string vibration sensing pickups 138. Processing may be performed onboard or externally. If external, the vibrato sensor signal may be transmitted by wireless means, or by a second conductor in a coaxial cable to the signal processor, or by a signal on a non audible or filterable carrier frequency transmitted on the main cable, or preferably by adding a filterable DC voltage bias to the music signal on the main output.

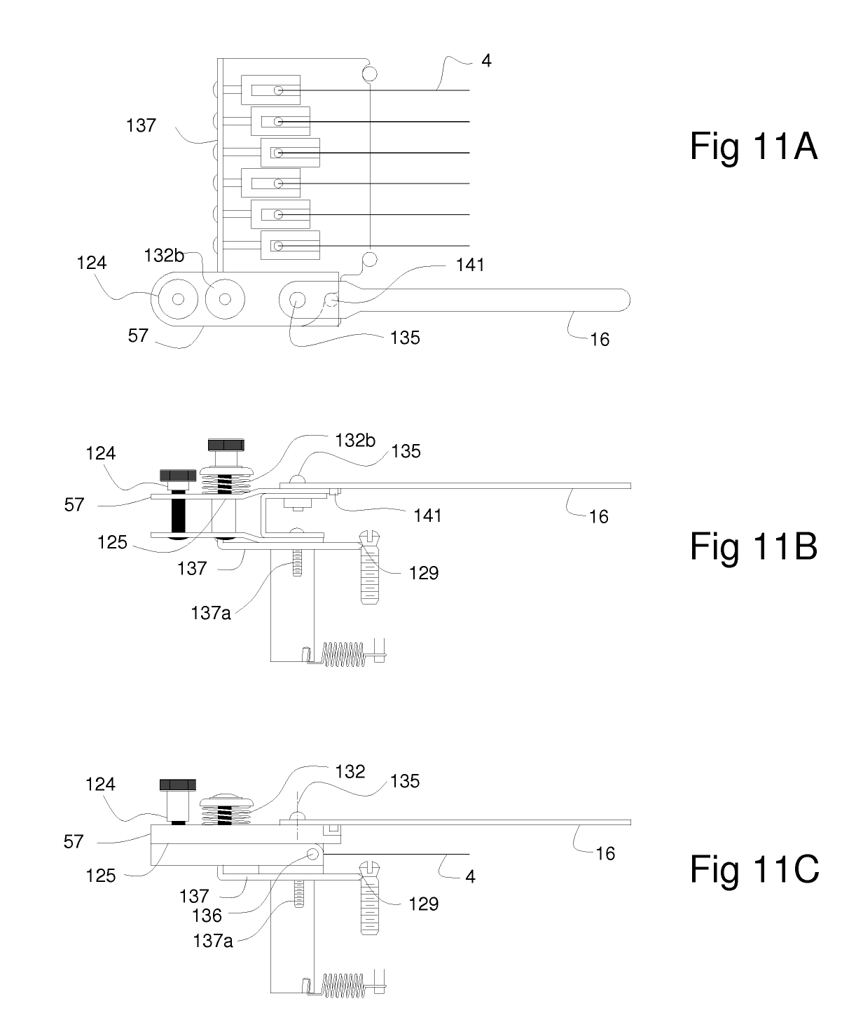

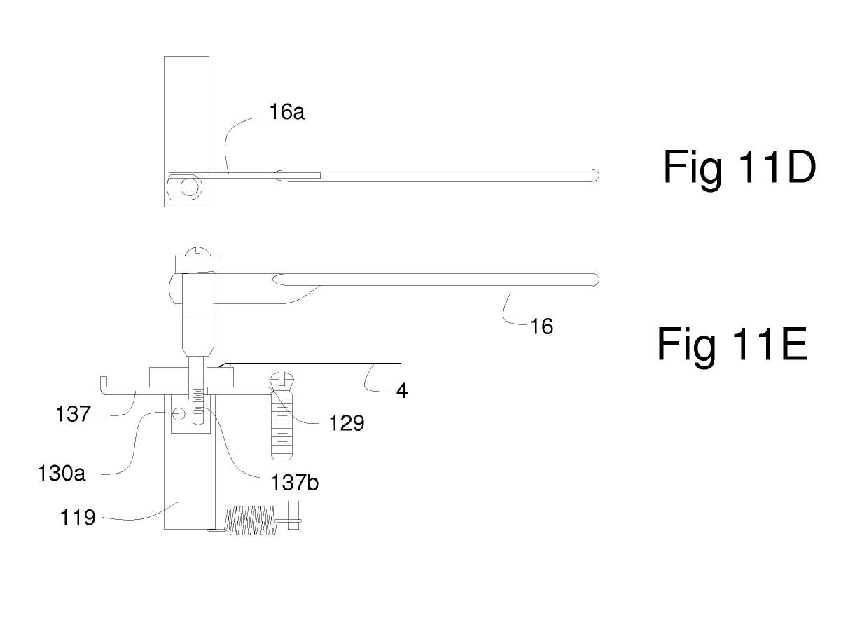

In the preferred embodiment shown in FIGS. 11A, 11B and 11C, the device is mountable to a standard vibrato 137, preferably by way of an existing vibrato arm socket 137a (preferably threaded). Harmonic dive transport 57 is lightly biased against bias stop 125 by preferably adjustable harmonic bias spring 132b. Pressing arm 16 toward body generates a dive effect electronically until transport 57 engages harmonic dive limit 124 (preferably adjustable by cam or screw means). Continued rotation of arm 16 toward guitar body rotates standard vibrato 137 on pivot axis 129 from its biased position, generating a standard dive effect mechanically.

Further in the preferred embodiment, rotation of arm 16 counterclockwise about vertical axis 135 (normal to string plane) generates no effect until the arm engages stop means 141. With further rotation (resisted by preferably adjustable spring means) processor means 133 generates a bend effect using signals from vertical axis sensors and pickups 138.

In the simplest embodiment, the arm 16 has only a single sensor 130a or 131a, measuring rotation relative to an axis substantially normal to the string plane, with the processor 133 using the signal therefrom to modulate harmonic dive and bend effects. The arm's rotation axis 135 is fixed relative to the standard vibrato device 137, so that rotating the arm toward or away from instrument body generates a standard dive or bend effect. Arm preferably includes detent or locking means to allow rotation out of playing position when not in use, and spring means 132a to provide rotational resistance about said axis when in use.

In a simple signal flow chart in FIG. 10E, signals from pickups 138 and arm sensors 130 (or 131) are digitized at first conversion stage 139. Digital signal processor 133 changes pitch of the entire sample in discrete overlapping time slices, preferably by simply compressing or expanding the sample, and then feeds the result to secondary conversion stage 140, which feeds one or more amplification stages 134.

Alternatively, both standard and harmonic vibrato effects may be generated electronically with the described arm motions feeding preferably dual axis data to said processor. Harmonic dive limit 124 is preferably replaced by simple switch contact means which signal processor 133 to shift to standard dive, either by separate means or by, for example, biasing or reversing the combined analog signal from the two rotary sensors. Lifting control arm 16 from the instrument body may optionally generate a standard bend.

Alternatively, digitized arm position signal may be processed into a MIDI signal and forwarded to a MIDI controller having pitch shift capability.

Auxiliary Pickup Piezo electric, magnetic, or inductive sensors may be implemented to sense vibration on any of the components of the present invention for amplification with or in place of traditional pickups.

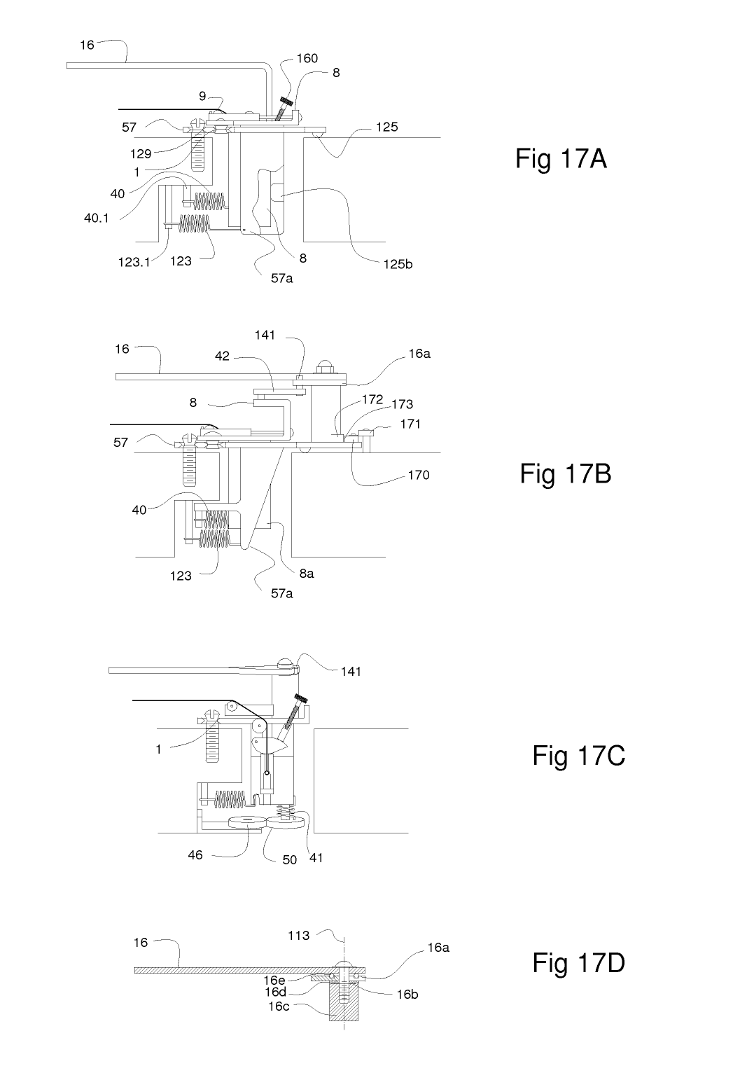

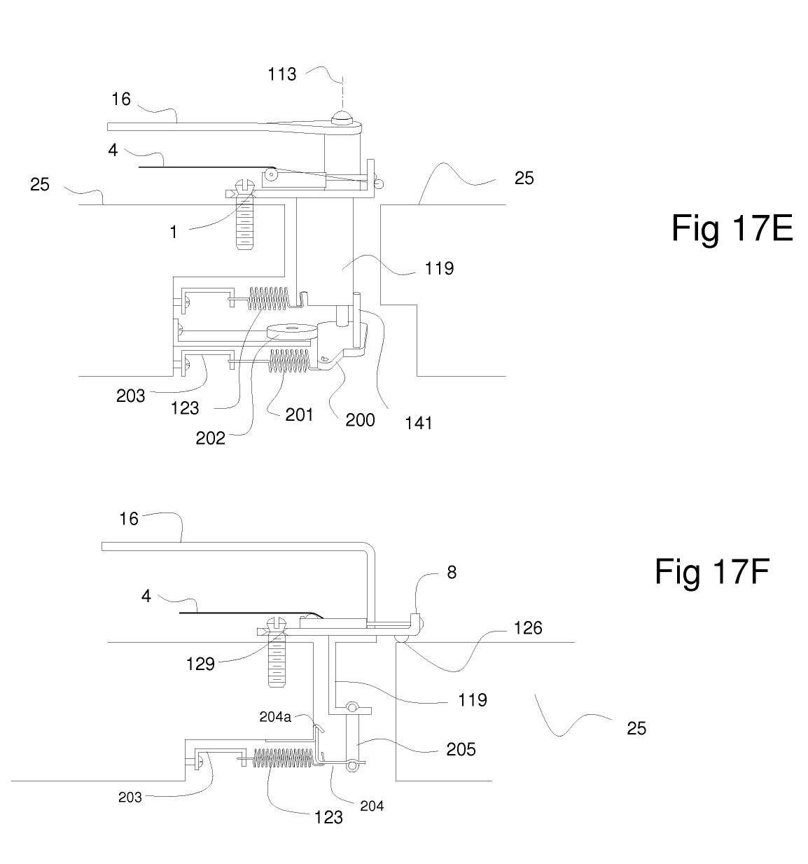

Improvements to a Standard Vibrato. FIG. 17A shows the simplest embodiment, in which a control arm 16 directly engages main member 8, rotatable about pivot axis 1 (for example pivot studs), fixed relative to dive transport 57 or guitar body. When released following a bend, string forces, partially balanced by optional balance spring 40, press main rotating member 8 against bend stop 125b, fixed relative to dive transport 57. Dive transport 57 is biased against standard bias stop 126 by a combination of bias spring force 123 between guitar body and dive transport extension 57a, and balance spring 40 between guitar body and main rotating member 8.

Bends, performed by lifting arm 16 away from the guitar body, rotate main member 8 off of bend stop 125b, fixed relative to dive transport. Dives, performed by pressing arm 16 toward the instrument body, rotate main member 8 and dive transport 57 off of dive bias stop 125.

If said balancing spring 40 is used, it is preferably chosen or adjusted such that any broken string will not change the bias direction at bend stop 125b. Balance spring 40 and bend stop 125b may be hidden within the guitar body, as shown, or mounted externally for easy access and adjustment.

The present method may be be used with either a standard rotating member 8, as illustrated, or a harmonic main rotating member 8.

When implemented on standard vibrato means, the present method preferably utilizes separate axes, 1 for bends (between main member 8 dive transport 57), and 129 for dives (between dive transport 57 and guitar body), substantially parallel to bridge means 9, and offset at least along string axis so as to maintain action height above frets during dives and bends. Harmonic bend and dive rotations are preferably performed on a common axis.

Similarly all other improvements to control action described herein for a harmonic vibrato device may also be used to advantage on a standard vibrato, as illustrated further in FIGS. 17B and 17C.

In FIG. 17B, the bend stop function (limiting return rotzation when said device is released from a bend) is served by linkage 42 between main member 8 and actuator crank 16a, engaged by arm 16, rotating on axis 113 fixed relative to dive transport 57.

Rotation of arm 16 and crank 16a around the control arm bend axis 113, preferably perpendicular to the string plane, pulls the main member 8, away from the headstock, increasing string pitch. As described elsewhere, any mechanical means may be used to transfer this rotary action to the bridge/tailpiece assembly, for instance a crank, roller crank, cam, or linkage as shown. Stop position may be determined as shown by axial alignment of linkage 42 with arm bend axis 113, or optional stop pin described elsewhere.

Rotation of arm 16 around the dive axis, (preferably by pushing the control arm toward the instrument body), causes said bridge and tailpiece assembly to pivot toward the headstock by virtue of the rigidity of pivot shaft, boss, and washers on the bend axis, rigidly mounted to either the first or second movable components.

Where the bend axis is perpendicular to the string plane, optional latch bolt means 170, urged into latch bolt receiver 171, preferably by cam means 172 rotating with arm 16, may prevent stretch of the bias springs 40 and 123 during extreme bends, eliminating the need for excessive biasing spring tension. Cam means 172 preferably has diminishing radius when rotated beyond bolt insertion angle, to reduce friction. This method of preventing inadvertent dives during extreme bends may be used on either a standard or harmonic vibrato device. Alternatively, said bolt may rotate directly with arm 16, creating a penalty in bend rotation effort.

In FIG. 17C, control arm 16 rotates on axis 113 preferably oblique to main member 8. Bias springs 40 hold cam 50 (on shaft 113a) stopped against cam follower 46 at rest. Rotation of arm 16 about axis 113 reduces contact pressure on crank or cam means 50, allowing bias springs 40 to pull tension into strings 4 by rotation of main member 8. Pressing control arm 16 toward instrument body rotates member 8 about dive axis 1. At rest. cam 50 and arm 16 are positioned securely in neutral position by suitable return spring means 41, and return stop means 125a. (or return spring cam means as described elsewhere)

FIG. 17D illustrates surface relief means useful in any control arm, where arm 16, crank 16a, arm pivot base 16c, or thrust bearing means 16d there between include relief means (16b) near axis 113, for example by counter bore means 16b or ball race 16e, to improve rigidity against rotation except about arm axis 113.

Full Floating Effect.

In the preferred embodiment, the ability to bend and dive simultaneously by rotating control arm on separate axes allows the user to oscillate the device about the neutral tone position while using only the inner muscles of the hand and wrist, with no discontinuities caused by stops or flatted cams.

Extreme Bends

Any harmonic vibrato device is preferably configured with stop means to prevent main rotating member or individual strings from exceeding the string wire's allowable strain. Typically the high e-string is the most stressed, and those stresses must be considered when performing a bend, especially a harmonic bend.

Overshoot means may be employed to stop one or more string anchors from rotating past the yield point of their respective strings (for example the high e-string), while allowing one or more stings to continue to bend during normal bend action of the control arm.

This is accomplished in FIG. 16A by providing a limited rotating member 178 for (by way of example) the high E string, biased against a bias stop 176 on main rotating member 8 by separate bias spring means 175, preferably anchored with respect to base 69 or body. A high limit stop 177, rigidly attached to base plate 69 or instrument body, prevents said limited rotating member 178 from over-stretching its during rotation of main member.

Similarly limited rotating member 178 engages crank means for the first two strings in FIGS. 6b and 6C. Main rotating cage member 179 engages limited member 178 by bias spring means 175, and unlimited member 178a by rigid means 175a. Bias stop 176 and high limit 177 are also shown.

Alternatively, after bending rotation of main member is stopped by suitable limit means, an arm bias spring may allow arm to rotate from its bias stop and to further engage separate mechanism to bend one or more discreet strings, for example the b or g string, preferably by simple pulley or crank means.

In FIG. 23D, when bending rotation of main member 8 is halted by stop 177, continued rotation of arm 16 about arm bend axis 113 tilts overbend transport 57a to vary the tension in one string.

An embodiment which may be preferred for its low reactive forces employs separate pivot means to allow arm to pivot upwards from body (about an axis parallel to bridge means) and engaging separate mechanism to bend one or more discreet strings, for example the b or g string, or it may pivot the entire tailpiece and bridge assembly about its standard pivot axis, away from head, allowing the g and b strings to bend more than they would in a harmonic bend.

Alternatively, the high E-string may merely be anchored relative to the body or base 69, or adjusted for zero travel, so that its tension is unchanged during harmonic bends, thus allowing higher bends without damage to that string. In the quick change embodiment of FIG. 15, a flat plate rotating member 8 has a mounting slot or hole to accommodate auxiliary guide 6b, positioned for reduced pitch increase. The path of the high e string 4a around guide 6a may be be rerouted to path 4b around guide 6b. Guides 6a and 6b are preferably of larger diameter to reduce cyclic stress.

Alternatively, the entire device may be simply detuned using the control arm or transposing means prior to the bend, thus allowing wider bend range without exceeding string tension limits.

Tuning Stability

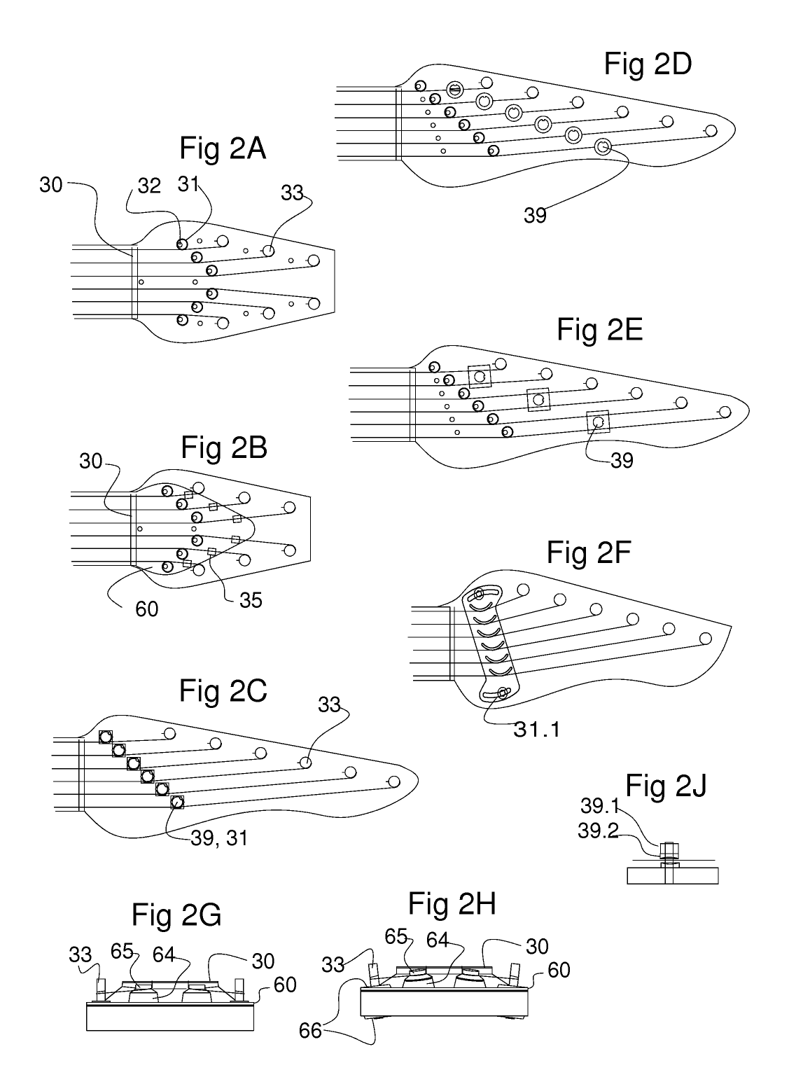

For improved precision and to prevent losing tune after a dive, the present invention may be implemented in combination with clamping of strings at the tuning head nut, as is known, or it may preferably be implemented using a low-friction zero fret 30 or nut means, preferably in combination with string guide means 31, and having locking means at or beyond said guide means, for example, commercially available locking tuners 33 of the type that will tune a string in less than one full turn of the tuning post. (FIG. 2A)

In FIGS. 2A, 2B, 2C, and 2D the guide means 31 preferably has adjustment means 32 for moving parallel to the nut or zero fret, preferably by an eccentric having an axis substantially perpendicular to the string plane. Alternatively guide spacing may be adjusted by pivoting a multitude of guides about a single axis, for instance in the center or at one end of a gang casting 34 as in FIG. 2E, where pivot and locking means may be a simple screw into the tuning head.

The use of a guide means 31 beyond a zero fret 30 provides improved playability, allowing the “string bending” technique to be used with lower effort near the head end of the neck. Means for adjusting the position of guides in a direction parallel to the strings allows adjustment of “bendability”. Said adjustment may be, by multiple choice of mounting locations 31.1, or by other means. Proximity to the nut or zero fret reduces harmonic losses.

Alternatively, precisely or adjustably located locking tuners of the type previously described provide some benefits when used in combination with other components of the present invention. For example, tuners may be mounted with the post through an eccentric bushing.

“Action height” In FIG. 7B a zero fret or nut is preferably elastically cantilevered about a bending axis parallel to said zero fret, and is adjustably secured from motion and vibration by compressive set screws 61.1 and tensile hold down screws 61.2.

The cantilever is preferably the extreme end 62 of the fingerboard itself, preferably having interlaminar reinforcement 63 at the line of separation from the neck, for example anchor screws or stitch means substantially perpendicular to the fingerboard.

Retrofit

The present vibrato invention may be made to retrofit onto an existing guitar by bolting baseplate means 69 or 76 to the guitar body. Alternatively, base means 69 or 76 may be the guitar body itself.

A preferred retrofit tuning head flange assembly in FIG. 2B, for example to fit to a highly raked tuning head, includes a flange 60, preferably of flat metal or composite, to which is attached string bearing means 35 to reduce string angle across zero fret or nut and string guides 31 preferably having adjustment means 32 to adjust string spacing, A nut or zero fret 30, preferably with vertical adjustment means, may also be incorporated onto said flange.

For retrofit of flange 60 onto severely raked tuning heads, as in FIGS. 2G and 2H, string bearing means 35 and string guide means 31 are preferably combined into a single roller 66 for each string, preferably having lateral adjusting means, for example eccentric or slotted mounting means. With a beveled flange on said roller 66, boss 65 aligned with bearing axis may be normal to head face as in FIG. 9H, or preferably canted, as in FIG. 9G, with axis substantially normal to the plane of the string path. Tuning machines 33 are preferably mounted with with axes normal to string plane at tuner, for example using beveled boss 67 to align tuning machine 33 to guide roller 66.

Control arm 16 preferably has separate outer arm 16b, positionable by adjusting means 16c, for example opposed flanges compressed by screw means as in FIG. 12A.

Arm may have control surfaces engageable by players fingertips substantially normal to each major direction of motion, as in FIGS. 9A and 16H. In an alternate embodiment, one or more projections 73 extend substantially radially from an arcuate control arm 16. as in FIG. 12A. FIG. 12B shows an alternative embodiment wherein control arm extends under pick guard or other solid surface means 79. Control end 73 may extend in any direction from arm 16. Alternatively, arm may be bent to desired shape by user, as is common in the art.

Any alternative means of engaging vibrato device may be applied, for example a footpedal with flexible cable coupled to the control cam, or coupled directly to the main rotating member.

Rotation of control arm in two planes may be used to perform 2 differing tonal adjustments, for instance bending the b-string or some other subset of strings may be assigned to rotation in one plane, while rotation in the other plane affects the entire string complement.

Alternatively rotation in one plane may be used to set and release locking mechanism or brake for the rotation in the other plane.

An optional second adjustable stop means 49 (preferably a manually adjustable cam and follower) in FIG. 9A (between rotating vibrato member 8 and instrument body) may act as a low pitch stop, so that when control arm 16 of an unbiased device is released, main rotating member will come to rest on said stop.

### Float About Neutral Position.

It is desirable on any vibrato mechanism that biasing forces be maximized at rest while providing for smooth easy travel of the arm during dives and bends. It is further desirable in a device having a dual axis control arm mechanism that rotation in one axis not cause, for example, inadvertent deflection of dive biasing spring due to increased string tension during a bend.

String force during a harmonic bend with a the described device is less than a maximum bend with a standard device, due to the reduced stretch on all strings except the high E string.

A preferred embodiment uses mechanical means having nonuniform purchase to generate a dive when the transport means is tilted. The high purchase at rest resists inadvertent dives due to increasing string tension, while the lower purchase when activated provides both increased response and more constant effort over the dive range.

An example of such mechanical means shown in FIG. 25C, uses two rollers having axes in substantially perpendicular planes, one mounted to the control arm shaft or journal 113b, and the other mounted to the main rotating member 8. One of the rollers preferably has an axis substantially parallel to the dive pivot axis 58, and the other preferably has and axis substantially parallel to the bend pivot axis 113.

One or both rollers may be axially contoured to improve the feel and reduce effort in bend and dive action. The roller mounted to the main rotating member 8 is nominally the cam follower.

Pivoting said control arm in a bend direction about said bend axis causes forceful separation of said cam follower and said bend axis. Tilting said dive transport about its dive axis allows string tension to reduce said separation, by controlled travel of cam follower across the axial contour of said roller. (Note said contour may alternatively be solidly fixed to said rocker, eliminating said roller, with a mild penalty in required bend effort.

The bend and dive functions may be performed by two separate mechanisms, and in another embodiment of the invention, the dive mechanism uses a cam surface or crank to vary the purchase with the travel of the main rotating member.

FIGS. 25A through 25D illustrate examples of control arms having journals 113b rotating on shafts rigidly cantilevered from the base 69.

In the simplest embodiment, FIG. 25A, the journal includes a circularly cylindrical outer surface against which rotating member 8 or separate resilient stop material 125a rests when arm is inactive. Said cylindrical surface acts as a brake against said journal when inactive, to hold control arm 16 in playing position or away from playing position. Separate rocker, or cam, or roller means 43 presses against roller or follower 46 to rotate main member 8 in a direction to increase string tension, when control arm is rotated about its axis 113 in a bend direction. When control arm is pressed toward instrument body, the rigidity of said cantilever rotates base 69 away from stop 126 to generate a standard dive. When released, standard bias springs 123 (preferably pulling on spring block 119) return base 69 to its at rest position.

In FIGS. 25B, 25C, and 25D said journal 113b includes pivot bearing means 58 to support dive transport lever means 57, said transport biased against said journal by harmonic dive bias spring 122.

FIG. 25B illustrates the application of such a transport to a simple tensile linkage between said transport 57 and said main member 8.

FIG. 25C illustrates the application of such a transport to a control mechanism wherein two rollers rotating on (preferably perpendicularly) skewed axes allow low friction rotation of control arm 16 about either the bend axis 113 or the dive axis 58.

In FIGS. 25C, 25D, and 25E the master roller 211 drives slave roller 212.

In FIG. 25D, one of the 2 skewed rollers is axially contoured in order to increase the torque on control arm 16 generated by string tension as the arm progresses through a dive, thus partially compensating for increasing torque generated by bias spring(s) 122, and improving the feel of the device.

FIG. 25E shows a similar contoured roller configuration wherein transport 57 comprises a journal rotating on a shaft 58a cantilevered from (preferably)) a plate 69a projecting from base 69.

From FIGS. 25D and 25E, force vectors and moment arms about transport dive axis 58 may be compared for two dive positions. The string force vector 210a at rest is high but its moment arm from the dive pivot axis 25 is short, leading to stability at rest. When displaced in a dive the string force vector 210b diminishes, but its moment from axis 58 increases, reducing manual effort necessary to overcome the torque of dive bias spring 122.

The shafts cantilevered from base 69 or 69a in FIGS. 25B to 25E may alternatively be cantilevered from said main moving member 8. Transposing means as described elsewhere herein may also be incorporated into said embodiments, with master or slave rollers displaced by transposing mechanism.

Skewed rollers may be implemented with any suitable arm and transport configuration.

An alternative embodiment applicable to standard or harmonic bends includes a dive lock bolt mechanism (as shown in FIG. 17B) to prevent inadvertent dive during extreme bends. Slight rotation of the control arm in the bend direction causes the bolt to engage the receiver, preventing the transport from rotating in the dive direction. Actuation of said bolt means by said arm rotation is preferably via cam means, with cam radius diminishing or constant during further rotation after said actuation, to avoid restriction of bending motion.

### Isolation

Harmonic dive bias springs anchored relative to body or sub base may prevent inadvertent standard dive by increasing the net standard force bias away from the tuning head, particularly if said harmonic bias springs are oriented normal to the string plane, and the harmonic dive pivot axis is located a substantial distance from the standard pivot axis in the direction of the harmonic dive bias springs. In this instance, downward pressure on the control arm creates downward force at the harmonic dive pivot axis as a multiple of the harmonic dive bias spring force, and that downward force prevents unwanted rotation of the base about the standard pivot axis.

Therefore, at least part of the harmonic dive bias spring set should be anchored relative to the body (anchored to the body or subbase) rather than to the base. In this configuration, depending on the placement of the harmonic dive pivot axis, and the bias spring force direction, little or no standard biasing spring may be necessary.

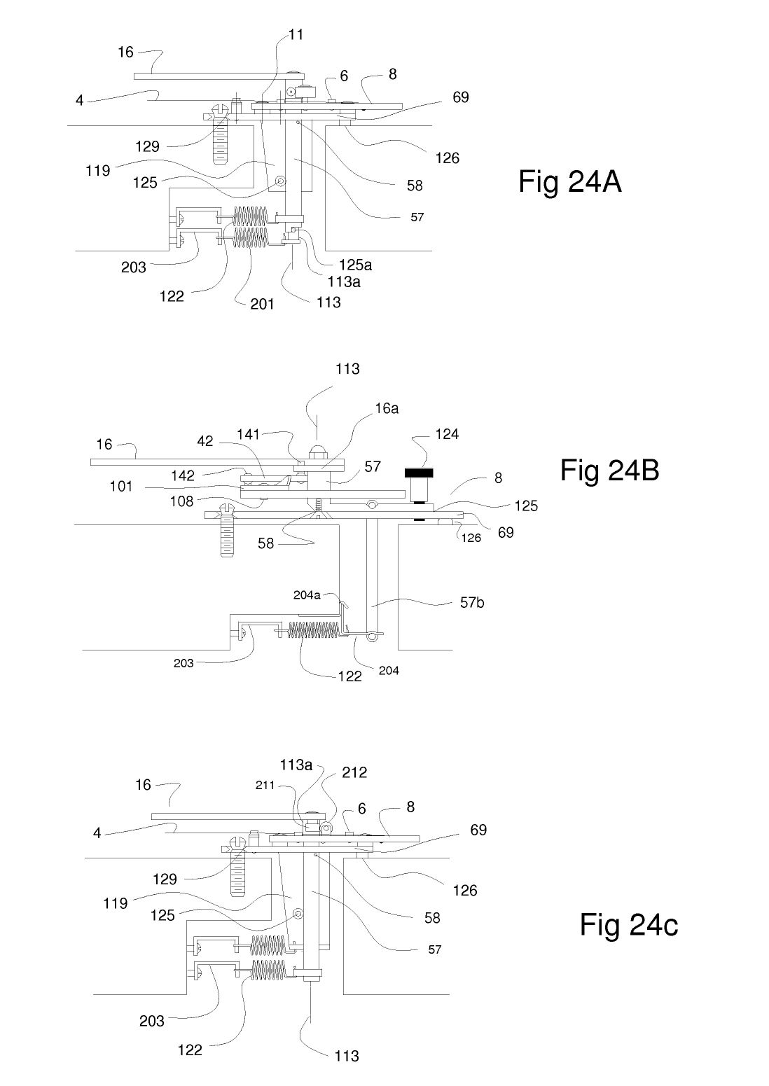

In FIG. 24B a connecting rod extends through the body (perpendicular to the string plane) from the harmonic dive transport (pivoting on an axis substantially parallel to the string plane) to a bellcrank 204 within the body, and in turn connected to bias springs extending substantially parallel to the string plane. Typical bias spring and claw configuration of the prior art may be connected to the bell crank, for example.

By redirecting the force of the standard bias springs, the bell crank provides the following benefits: 1) High bias spring tension (desired by some musicians to improve tone) does not create excessive stress on standard pivot posts, as in the prior art. 2) springs may be located away from magnetic pickups to prevent unwanted signals, and 3) rod connection may be located at an oblique angle from crank axis so as to provide variable purchase as crank rotates, thus reducing required spring tension.

Alternatively, said harmonic bias spring may extend normal to the string plane, thus eliminating the bellcrank, or a crank (integral with said harmonic dive transport) may extend through the body substantially parallel to a standard spring block as shown in FIG. 24A.

For musicians who prefer high bias torque at rest in a quest to maximize sustain, this embodiment allows maximizing bias torque at rest. This configuration allows reduced effort along with increased sustain.

In a preferred configuration, a combination of bias springs would exert forces both parallel and normal to the string plane.

### Bias Force Adjustment During a Dive.

Harmonic dive transport bias springs are terminated on the body of the instrument (or sub base) rather than the base plate, thus reducing the required tension on standard bias springs, and minimizing playing effort.

In FIG. 24B, the bias spring (in either a standard or harmonic device) anchored to the body 25 engages a variable purchase device, for example a bellcrank 204 on bellcrank pivot 204a, as shown, said bellcrank in turn engaging a connecting rod 57a, in turn connected pivotingly to the harmonic dive transport 57.

Bellcrank is preferably configured to reduce the purchase of said bias spring on said connecting rod as the transport rotates from its stop 125 about transport pivot 58. This configuration allows a lower spring force to effect higher biasing torque on the base 69 when at rest, while creating less force on pivots 129 parallel to said strings. Said pivot surfaces are preferably angled to resist downward force on said base

On a standard vibrato, the connecting rod may connect to a dive transport or directly to the main rotating member 8, or to a block extending from said member 119, as illustrated in FIG. 17F.

Multiple bias springs according to more than a single embodiment described herein may be implemented in a single instrument, to achieve the desired effect.

For musicians who prefer high bias torque at rest in a quest to maximize sustain, the embodiments of FIG. 24B (and to a lesser extent FIGS. 17E and 24A) maximize the bias torque at rest without excessive bias torque during a dive.

### Bias Force Adjustment While Bending.

In FIG. 17E, a bend return spring(s) 201, acting through bend return crank 200, induces torque in control arm 16, opposing the torque induced by bias spring(s) 123 and follower 202, preferably fixed relative to body 25. Arm bend shaft 113a rotates on axis 113, with axis preferably fixed relative to main rotating member 8, substantially perpendicular to the string plane 4.

Rotation of control arm 16 about bend axis 113 reduces force between follower 202 and crank 200, allowing the force of bias springs 123 and return spring 201 to pull the strings to higher pitch by rotating vibrato rotating member 8.

Bend stop 114 limits the return rotation of return crank 200 when at rest. (It is shown as a pin for schematic purposes only, and may be of any functional form. One of the stop surfaces is preferably of a resilient material.)

Separate standard bias spring 123 and return spring 201 are preferably separately adjustable, for example by separate claws 203, as are common in the art.

Similarly In FIG. 24A the same method may be used to prevent inadvertent harmonic or standard dive during an extreme harmonic bend, when the bend axis is substantially perpendicular to the string plane.

### Simulated Dual Axis Operation

Still another alternative embodiment of the invention simulates dual axis control by extending the control arm from pivot means having a single pivot axis substantially parallel to the strings.

Rotation of said arm toward the strings engages the vibrato device through suitable mechanical means to generate a bend effect, while rotation away from said strings and toward instrument body generates a dive effect. Said device preferably includes one or two biasing means to provide a free floating or a stable floating effect about the neutral position.

### Separately Biased Stop.

In a floating vibrato design where the control arm pivots about a single axis, it is desirable to force the device to seek its neutral position precisely when released. This is achieved by stop means, preferably resisting relaxation of the string, and separately pressed against secondary stop means by separate spring means, as previously described in FIG. 17A. With proper selection of balance spring 40 and bias spring 123, failure of a string will have no effect on neutral position of the device. Stops and springs may be located at any convenient location, and provided with adjusting means accessible to the performer.

In FIG. 21A, stop 126 is pressed against secondary stop 56.9 by stop bias spring 56. In the event of a broken string, spring force may be adjusted by spring adjuster 56.1 to maintain a good feel to the device, and prevent bias springs 123 from overpowering stop bias spring 56.

### Transport Separate From Device

It should be noted that any part or all of the control arm and transport combination may be mounted apart from the other components of the device and connected by linkage above, below, or through the body of the instrument.

For example, mounting the control arm pivot axes farther toward the tuning head allows good tactile response due to the improved angular purchase, while avoiding clutter on the face of the body.

### Hidden Mechanism.

It should further be noted that the disclosed device may be fabricated with any part or all of the actuation mechanism concealed within the instrument, including control arm pivot, transport means, and transposing means, and associated springs.

Said device may be implemented as a retrofit unit or built into an instrument. Said instrument body may act as the base or sub-base previously described.

In particular, the control arm shaft or shaft extension may extend below the hub or a cam or rocker may be extended from the control arm hub through the base to engage the spring block below the face.

### Ball Cup Pivots

Ball cup string anchors may be slotted to allow string to exit said anchor at a non-stressful angle, with ball rotating within said anchor. Said anchors may be located so as to center the ball at the guide location.

### Bias Force Adjustment While Transposing.

To maintain playing ease, mechanical means may be provided to modify the force of balance springs, bias springs or dive bias springs when transposing to a lower key.

In one simple embodiment, the transposing hub is threaded onto a screw to adjust the compressive force of the dive bias spring or of an opposing dive helper spring.

In the preferred embodiment, rotation of said transposing hub moves the fulcrum point of a biasing leaf spring to change both the force and the spring constant of said bias spring.

### Extreme Bends

The simplest way to incorporate extreme bends of the b or g string is to allow the tailpiece to rotate back on its standard pivots creating a standard vibrato bend when the control arm is rotated away from the instrument surface.

To accommodate this feature in a stable manner, the device, the first standard bias stop 126 is separately biased against secondary standard bias stop 56.9 by secondary bias spring or springs 56, as shown in FIG. 21A.

The assembly of bias stop and springs may be secured relative to the rotating standard vibrato base 69, or relative to the instrument body 25 (or sub base).

Additional Notes

Because the pitch of a string varies with the square root of the string stretch, and the scale of the invention is large, the invention is robust enough to allow significant deviation from optimal design without creating excessive transposing errors. Thus any configuration substantially equivalent to the preferred optimal configuration falls within the scope of the invention. The low angle of rotation allows strings to wrapped about geometrically wrong side of said guide or about a guide in a geometrically incorrect track without excessive harm to pitch accuracy. Guide means may be visually placed by measurement or by index marks included on the device, and a small error in placement will be undetected acoustically.

An embodiment of the invention taking advantage of said tolerance in a flat plate configuration may use fewer than the total complement of arcuate paths. It may also use additional (for example parallel to the high e path) non converging paths to allow flexibility in setting up said device for multiple tuning. Where multiple paths converge near the main pivot axis, one may continue while the others terminate short of the convergence point. Alternatively, a less preferred configuration may employ a perforated plate straight slots approximating the preferred configuration. (FIG. 15). Straight or curved slots may be configured to increase the string angle from tangency for the lower tuned strings to partially offset neck flex.

A control arm axis normal to the string plane as disclosed herein is additionally beneficial when applied to acoustic guitars, where motion of the control handle will not conflict with vibratory rotation of the sounding board about the bridge.

Mechanical construction listed above is by way of example and conceptual schematic only. Any configuration functioning according to the described principles falls within the scope of this invention. In particular switching locations of cams and cam followers, rotating axes, and utilization of mechanical linkage in place of cams, or vice versa, falls under the scope of this invention.

Size, shape and location of components shown was selected for clarity of illustration, and not to illustrate a preferred size or shape or location. Variations, which may be obvious to those skilled in the art, fall within the scope of this invention.

Mounting locations and axes of control arm, cams, cam follower, transposing hub, or linkage may be interchanged, reversed, or inverted from that shown.

In FIGS. 21B-23D where balancing spring 40 or harmonic dive bias spring 122 extending from rotating member 8 within the instrument body is shown anchored to base extension 119b, it should generally be clear that said spring may alternatively be anchored to the base 68 or to the body 25 in lieu of or in addition to standard bias spring 123.

As an alternative to FIG. 5B, the fine tuners shown may alternatively pivot about the guides 6.

Stops or other limiting devices may be relocated as desired.

String bearing means may serve also as bridge saddle means.

String guide means and string anchors may be combined into a single component or adjacent components, and ball cup anchor means may be pivotally suspended between guide means and bearing means.

The “substantially arcuate” adjusting path of string guides on a flat plate embodiment may include linear slots or discrete holes, as shown in FIG. 15.

Main rotating member pivot axis “substantially parallel” to the plane of the strings includes axes slightly oblique orientation to accommodate differences in crank length from lowE to highE.

Spring anchors shown in some drawings as rigid pins are schematic representations, and actual embodiments may be expected to include adjustable claw, or other spring adjustment means.

The term “vibrato” used in this specification and claims is intended to include temporary increase or decrease in string pitch with or without oscillation.

Where an activation mechanism is disclosed by way of illustration as it is applicable to a given vibrato device configuration, it should be understood that the invention is not limited to a vibrato of that style or rotating about that same axis, but includes any vibrato device configuration to which it applies.

The invention resides in the specification and claims and in those improvements and modifications which may become obvious to those skilled in the art.

I claim:

1) A device for changing the pitch of a musical instrument, said instrument having a body, multiple substantially parallel strings substantially in a common plane, said strings having a first and second end and suspended in tension over a playable span, said device engaging the first end of two or more strings of said instrument and further comprising in combination:
a) A base defined by or attached to said instrument body.
b) A first member, said first member rotatable relative to said base about a first axis,
c) Displaceable guide bearings or bearing means, one for each of said two or more strings, with each position adjustably fixable relative to said first member, and displaceable with rotation of said first member.
d) Multiple string support bearings, each in contact with one of said strings, the position of said bearing adjustably or non-adjustably fixed relative to said base means, said bearing engaging said string at a point between said playable span and the anchor point of the first end of said string.
e) force coupling means connecting the playable span of each string to one of said displaceable guide bearings, so that displacement of said guide bearing causes a change in the tension of said string,
And wherein said displaceable guide bearings are adapted to define the force connection pivot location between said first member and said force coupling means, where said adjustability allows positioning of each of said pivot locations a discreet radius from said first axis when said first member is at rest,
and wherein said components are configured such that the force coupled to said guide bearing intersects an arc about said first axis substantially at a point of tangency, or substantially at a common angle from tangency among said guide bearings, when said mechanism is at rest.

2) A device as described in claim 1, wherein for each of two or more strings,
a) said force coupling means comprises the first end of said musical string, extending in tension between said support bearing and guide bearing means,
b) adjustment of said guide means positions said guide substantially rigidly relative to said first member.
c) string anchor means is substantially (rigidly or pivotingly) fixed relative to said first member or guide means.
d) said support bearing means is adjustably or non adjustably fixed relative to said base means, with bearing axis substantially parallel to said first axis or normal to the plane of said strings, wherein said bearing is rotatable about a bearing axis, and includes string constraining flange surface means oblique to said bearing axis.

3) A device as described in claim 2 wherein the adjustable position of each said guide bearing is constrained to a path substantially arcuate about a second axis substantially parallel to first axis of rotation, with said second axis substantially fixed relative to said first member and located substantially between said first axis and said string support bearing, and wherein said constraint comprises one of the following,
a) an arcuate slot cut into first member, through which screw or other fastener means may secure guide to said plate, where first member comprises substantially flat plate means having first axis substantially normal to the plane of said strings.
b) a slot having parallel axially uniform edges on a first member having cylindrically curved surface substantially about said second axis, substantially parallel to said a first axis, with said first axis substantially parallel to the plane of said strings and substantially perpendicular to the string direction.
c) crank or rocker means supporting said guide relative to said first member, pivotably adjustable about said second axis by screw or other means radially displaced from said second axis.
d) slot, track, drum, crank or other means fixed to a rotatable first member of any configuration meeting the requirements previously described.

4) A device as described in claim 2, wherein said first member comprises substantially flat plate or coplanar track means constraining said guide bearings to a plane substantially parallel to said base, with said plate or plane further subtantially parallel to the plane of said strings, and substantially displaced therefrom, with said first axis substantially parallel to said plate or plane, and wherein:
a) position of said guide means on said first member is adjustable along slot or track means substantially parallel to said strings,
b) string support bearing means are adjustably positioned on said base near said string plane and at locations substantially opposing the guides on said first member,
c) standoff means extends from base to support said firs member at said first axis with pivot means.
d) position of said support bearings adjustable by set screw means is a direction parallel to or normal to said string direction.

5) A device according to claim 1, wherein
a) said first member comprises master crank means having force receiving surface extending radially from said crank axis in a direction substantially parallel to said strings
b) said force coupling means includes slave crank means supporting said bearing means and anchor means for each said string,
c) slave crank pivot axis is adjustably fixed relative to said base, and is substantially parallel to string plane, and substantially coincident with a plane substantially normal to said strings,
d) slave crank means includes arm means with force receiving surfaces extending radially said crank axis in a direction substantially parallel to strings
e) said force coupling and guide means further comprise one of:
i) tensile link means, having spherical or cylindrical ends engaging adjustable guide mean on master and slave crank arms,
ii) spherical or cylindrical bearing means in compression between master and slave crank surfaces and adjustably fixed relative to master or slave crank by guide means.
iii) or, spherical or cylindrical bearing means adjustably cantilevered from master crank or slave crank hub means and forcefully engaging the crank arm surface means of the other,
f) string anchor means is fixed relative to slave crank means, or includes finetuning means to adjust string tension.
g) string bearing surface is substantially displaced above slave crank pivot axis.

6) Pitch control means for a musical instrument, said instrument having a body and a face surface, wherein a pitch changing device includes means to increase or decrease the pitch of a musical instrument from a neutral pitch in response to manual rotation of a control arm in one of two or more operative directions, and to return accurately to said neutral pitch when said arm is released, said arm rotating about a first arm axis fixed relative to arm pivot shaft or journal means, and further having mechanical means to isolate the pitch changing effects of rotation in different directions, which means includes one or more of the following components:
a) Mechanical means confining at least one direction of said control arm rotation to a rotational axis substantially normal to the axis of rotation corresponding to at least one other said operative direction of rotation.
a) Arm biasing means urging said control arm toward a neutral pitch position, said means including cam follower means energized by spring means toward cam surface means, where either cam or spring means is fixed relative to said arm, and the other fixed relative to said arm pivot base, and said cam having a bias surface, wherein spring pressure of said cam follower on said bias surface returns said arm to neutral position when released by user.
d) Transport means hinged relative to and biased against a fixed or moveable component of said vibrato device, or against said instrument body; where said control arm shaft or journal is mounted rigidly to said transport means along an axis substantially perpendicular to said transport hinge axis, such that rotation of said control arm in one direction about the hinge axis rotates said transport means from its biased position.

7) Pitch control means as described in claim 6, wherein said instrument or pitch changing device further includes:
a) multiple substantially parallel strings in a substantially common plane,
c) a vibrato first member engaging two or more string, slidingly or rotatingly movable relative to said base means to adjust the tension of said strings.
c) bridge means, wherein the contact line of said strings with said bridge is substantially normal to said strings and parallel to the plane of said strings.
d) base means fixed to, integral with, or pivotally engaging said instrument body
e) control hub means rotating on shaft or journal means fixed relative to said control arm first axis, said hub means tangentially fixed to or engageable by said control arm, wherein rotation of said arm in at least one direction rotates said hub in unison with said arm,
e) mechanical means by which rotation of said control hub means in at least one direction from neutral pitch position about said first axis generates linear or rotary movement of said first member relative to said base, said means including one or more of the following:
i) cam means fixed relative to said hub, engaging cam follower means on first member or base means.
ii) crank or rocker means fixed relative to said hub engaging cam follower on first member or base means
iii) eccentric roller fixed relative to said hub engaging surface means on first member or base means.
iv) crank or fixed relative to said hub engaging first member or base means via intermediate connecting rod.
v) screw means fixed relative to said hub, engaging stop means on first member or base means,
vi) rigid mechanical engagement between said control hub and first member relative to said control arm first axis.
vii) transposing means adapted to adjustably displace the point of fixation or point of engagement of said mechanical means to said hub, base, or first member, or transport means hinged thereto, relative to said transposing axis.

8) Pitch control means according to claim 7, and wherein said transport means is hinged relative to said base or first member and biased by spring means or string tension or both against stop means relative thereto,
a) where said control arm hub shaft or journal means is substantially fixed normal to plane of strings when said transport is at rest, and
b) where the point of engagement between control arm and said first member or base is radially displaced from said transport hinge axis in a direction substantially normal to motion of said point of engagement during use, and
c) where rotation of control arm in one direction about said transport hinge axis rotates said transport from its stop, displacing said engagement means to rotate first member about said first axis and thereby change string pitch.

9) Control means as described in claim 8, wherein said base includes hinge or pivot means rotation relative to said body or separate sub-base means, and where said base hinge axis and said transport hinge axis are substantially parallel to said bridge means, and further including:
a) Transport transition stop means, engageable by said transport means to limit the rotation of said transport about said hinge axis,
b) Means for adjusting the limiting angle of rotation of said transport means relative to said base, where said adjustment means comprises an engagable surface of said stop or said transport, adjustable by screw, axial cam, or radial cam means, where said cam surface is continuous or interrupted,
whereby, rotation of control arm and transport means beyond the angle of engagement with said transition stop means transfers torque to said base, rotating it from its biased position, and generating non-pitch-relative changes in string pitch.

10) Control means as described in claim 7, wherein said first member is adapted to maintain relative pitch among strings when changing string pitch, and further including said transposing means for adjustment of string pitch independent of said control arm motion, said transposing means having a transposing hub rotatable by handle or knob means about a transposing axis relative to said control arm, first member, base, or transport means hinged thereto, stop means detaining said transposing hub at a user selectable angular position, where rotation of said transposing hub adjusts the at-rest angular position of said first member.

11) Control means as described in claim 10, where said transposing means further includes means to substantially maintain angular alignment of control arm during rotation of said transposing hub, where said alignment means includes one or more of
a) idler lever means operatively inserted between control hub and transposing hub means, and further engaging cam, crank or link means extending from said transposing hub, further engaging cam, crank, or connecting rod means extending from said control hub.
b) idler link means operatively inserted between control hub and transposing hub means, and further pivotally engaging crank means radiating from transposing hub axis, and further engaging said control hub by rod end pivot means, or cam or roller crank means of said control hub in contact with rolling or static follower surface means on said link.
c) idler lever means operatively inserted between control hub and transposing hub means, said lever surface compressively engaging radially adjustable lobes extending from said transposing hub.

12) Control means as described in claim 7, including rotatable arm means having first arm axis oblique to said first member and fixed relative thereto, with said arm further operatively connected to screw, cam, rocker, or crank means, biased by string tension, spring force, or both against stop or cam follower means fixed relative to said base,
whereby rotation of said arm about said arm axis displaces said first member from its biased position, and
wherein the combined rotation of arm and first member about their respective axes confines said arm substantially to a plane parallel to said string plane when arm is rotated about said arm first axis, and
wherein rotation of said arm about first axis of said first member, by rigid shaft, journal, or thrust bearing means, causes rotation of said first member in the alternate direction, and disengagement of said screw, cam, rocker or crank means.

13) A vibrato or control means for a vibrato device as described in claim 7, having an arm with first rotational axes normal to said body face and second rotational axis parallel to said bridge means, wherein rotation of arm about first axis in a direction toward said strings generates and increase in pitch and rotating about second axis toward said body generates a decrease in pitch.

14) Control means according to claim 6, and further including
a) arm means pivotably fixed to arm pivot base means, with arm pivotable about one or two axes fixed relative to said base.
b) spring means adapted to maintain said arm in a preferred angular position about each said arm axis when at rest and to return it to said position when released.
b) means for mounting said base to an instrument body or to a mechanical vibrato device on an instrument body, where said vibrato pivot axis is substantially parallel to said face surface, and said arm pivot axis is substantially normal to said face when at rest.
d) means for electronically measuring displacement of arm from said at-rest position, and converting that measurement to an electronic signal, and transmitting said signal to a processor, enabling said processor to modify pitch of musical signal from said instrument and transmit said modified signal for amplification or other use.

15) Control means according to claim 14 and further including transport means, hinged about an axis substantially parallel to said vibrato axis, and forcefully biased by spring means relative to said vibrato means, and further including one or more of the following:
a) Bias spring adjustment by thumbscrew, axial cam, or radial cam means
b) Transition stop means whereby rotation of said transport means from its biased position is limited relative to said base, and whereby further rotation of said control arm or transport means in the direction engaging said transition stop means generates motion in said mechanical vibrato device, generating a combination of electronically and mechanically generated pitch change effects.
c) Processing means wherein said processor records oversized time slices of audio signal, and depending arm displacement signal, compresses or expands said signal timewise, outputting a slice of said compressed or expanded signal with a duration of approximately 1/(sampling rate), plus fixed or user selectable overlap time for fade in and fade out of said time slice with duration from 0 to 1/(sampling rate).

16) Transposing means as described in claim 6, for adjustment of musical key of the instrument, said transposing means including means to change the at-rest angular position of said first member without substantially affecting the at-rest angular position of said control arm, where said means include one or more of the following:
a) Advantageous positioning of transposing cam, crank, or screw means
b) idler link or lever means, further isolating said transposing hub from said mechanical means, where said idler link or lever is directly engaged by said transposing cam, crank, or screw means, and said link directly engages said mechanical means.

17) Pitch control means as described in claim 7, and further including means for increasing the range of pitch adjustment for a subset of said strings, where said means include:
a) division of said first rotating member into first and second members, where
b) said first member operatively engages the lower pitched subset of strings, and the second member operatively engages the higher pitched subset of strings,
c) said first and second members are rotateable about a common first axis, with said first member engaged by said control arm, and wherein
d) said second member is biased by spring means to stop means on said first member
e) and wherein stop means fixed relative to said base or body prevent engage said second member to prevent rotation beyond the yield limit of said higher pitched strings.

18) Pitch control means as described in claim 7, and further including means for increasing the range of pitch adjustment for a subset of said strings, where said means includes:
a) tangential bias of said control arm against stop means on a separate control hub by spring means urging said hub in the direction of higher pitch with respect to said control arm.
b) stop means between said first member and said base, limiting the rotation of first member and said hub beyond the yield limit of said higher pitched strings.
c) separate string bending means operatively engageable by said control arm and one or more strings, where
d) said string bending means comprising rod, lever, roller, cable, or other mechanical means, whereby
e) rotation of said control arm beyond the stop angle of said separate hub, in opposition to said bias springs, causes engagement of string bending means with said arm means and one or more strings, allowing further rotation of said arm to increase the pitch of said string or strings.

19) Pitch control means for a musical instrument, said instrument having a body, multiple substantially parallel strings in a substantially common plane, said device engaging two or more strings of said instrument and further comprising in combination:
a) Base means discreet from said instrument body.
b) A first member rotatable relative to said base means, having a first axis of rotation in a plane substantially perpendicular to said strings, rotation of which member is adapted to change the pitch of each string while maintaining substantially constant relative pitch ratios among the strings.
c) first mechanical means by which said first member may be forcefully engaged by the user to adjust its rotation about said first axis.
d) means to return said first member to it's at rest position as said forceful engagement subsides,
e) hinge or slide means coupling said base to said body or to a sub-base, while allowing pivoting or sliding displacement relative to said body,.
f) base displacement means by which said base means may be forcefully engaged to adjust the stretch of said strings substantially uniformly.
g) bias stop means fixed relative to said body or sub-base, against which string tension or bias spring force or both hold said base means when at rest.

20) Pitch control means as described in claim 19, wherein said first member is adapted to maintain relative pitch among strings when changing string pitch, and further including compensation means adapted to nonlinearly translate rotation of control arm, first member, or transposing means into displacement of base, bridge, or string anchor means relative to said body in an amount adequate to compensate for variations in instrument dimensions resulting from changes in string tension,
wherein said compensation means are components chosen from cam, wedge, crank, rocker, screw, cam follower and lifter components, directly or indirectly engaging said base means, and said body or a sub-base between said body and base.
wherein one of said components operatively connected to arm hub, first member, or transposing hub, engages another of said components operatively connected to said body, and
wherein nonlinearity of neck movement is approximated by adjustment of engagement location of cam or lever, or by precise cam shape, or by adjustably shaped cam, or by crank angle and diameter, or by adjustment of said compensating lever arm length.

21) Pitch control means according to claim 20 wherein rotation of said first member, or tranposing device, or control arm, causes relative displacement of a compensating cam and follower, where the force of said cam on said follower opposes the force of bias springs.

22) A vibrato mechanism as described in claim 1 wherein at least one string bearing is rotatable about a bearing axis, and includes string constraining flange surface means oblique to said bearing axis, and wherein said bearing axis is substantially parallel to said vibrato first axis of rotation, or normal to the plane of said strings.

23) A vibrato device according to claim 6 where said rotation of said control arm causes forceful engagement between two rollers having axes substantially skewed to allow rotation of said arm about two substantially perpendicular axes without substantial friction.
